(19) United States
(12) Patent Application Publication
(10) Pub. No.: US 2025/0258068 A1
(43) Pub. Date: Aug. 14, 2025

(54) APPARATUSES AND METHODS FOR CYTOPATHOLOGICAL STAINING

(71) Applicant: Cytobay Inc., Santa Monica, CA (US)

(72) Inventors: Wenjiang Chu, Santa Monica, CA (US); Danhua Wang, Santa Monica, CA (US)

(21) Appl. No.: 18/704,853

(22) PCT Filed: Nov. 30, 2022
(86) PCT No.: PCT/US2022/080638

§ 371 Date: Apr. 25, 2024

Related U.S. Application Data
(60) Provisional application No. 63/265,011, filed on Dec. 6, 2021.

(51) Int. Cl. G01N 1/31; G01N 1/34

(52) U.S. Cl. CPC G01N 1/312; G01N 1/34

(57) ABSTRACT

Disclosed herein are automated platforms, including apparatuses and methods of use thereof, for multiple staining and cytological slide preparation for a biological sample from a patient, such as a patient being assessed for a cancer diagnosis. Multiplexed staining of atypical cells in the biological sample enables increased sensitivity and specificity to confidently determine the presence of pathological cell types. The apparatuses and methods disclosed herein provide efficient and high-throughput approaches for cytopathological examination of patient samples.

### FIELD

Aspects of the present disclosure relate generally to automated platforms for cytopathological staining of atypical cell types, including cancer.

### BACKGROUND

Cytopathology studies the causes and pathogenesis of diseases, as well as changes in the physiological functions of cells during the occurrence of diseases mainly based on abnormal conditions within cells, so as to propose the basis for diagnosis, prevention, and treatment of diseases. Clinical examples include exfoliative cytology, fine needle aspiration cytology, blood circulating tumor cells, and other cytology (e.g. cytology during surgery, bone marrow, peripheral blood cytology, and AIDS cytology).

The positive identification of atypical cells, such as cancer cells, may be dependent on the interpretation of a trained pathologist. In order to ensure reliable interpretation and diagnosis, biological samples containing suspected atypical cells need to be processed properly, which generally involves staining the cells to enhance detection of morphological and/or functional characteristics. Furthermore, pathology professionals would benefit from more efficient procedures that do not sacrifice reliability of the cytopathological sample preparation. Accordingly, there is a need for improved apparatuses or devices, and accompanying methods of use, for rapid and specific cytopathological diagnoses.

### SUMMARY

Disclosed herein are apparatuses for performing multiplex cytopathological staining. Embodiments of the apparatuses comprise, at least, a staining container configured to comprise an aqueous cell medium, staining reagents, washing reagents, and/or slide mounting medium and cells from a biological sample from a patient and an extraction container configured to receive used aqueous medium, used staining reagents, and/or used washing reagents. The staining container and the extraction container are operatively separated by a semi-permeable membrane that may be permeable to the aqueous cell medium, staining reagents, washing reagents, and/or mounting medium but not permeable to the cells, such that the cells are retained in the staining container. Operation of the apparatuses disclosed herein permit multiple steps of staining and washing without significant loss of cells, which may happen through alternative methods, which use centrifugation and resuspension. This permits the staining of sample cells through multiple approaches, thereby improving the positive determination of atypical cells within the biological sample for cytology purposes, such as for the diagnosis of a disease.

Also disclosed herein are methods of using the apparatuses for performing multiplex cytopathological staining.

Also disclosed herein are pathology slide assemblies. Embodiments of the pathology slide assemblies comprise, at least, a pathology slide and a pathology coverslip, where the pathology slide and pathology coverslip are configured to be sealed and define an internal void accessible by an inlet port and an outlet port of the pathology slide assembly. The pathology slide may be coated with a cell-adhesive material that aids in adhering to and retaining cells of a biological sample within the internal void. Surfaces of the pathology coverslip may define an internal void within the pathology slide assembly that may be a single, “lake”-type reservoir, or configured to comprise one or more microfluidic channels.

Also disclosed herein are a plurality of pathology slide assemblies including two or more chained pathology slides as disclosed herein. These may be used to improve capture of cells in a sample by flowing the sample across more cell mounting surface area afforded by multiple pathology slide assemblies.

Also disclosed herein are methods of preparing and using the pathology slide assemblies disclosed herein. The cells that are mounted to the pathology slide assemblies provided herein may be stained and otherwise processed by the apparatuses for multiplexed cytopathological staining disclosed herein.

Also disclosed herein are apparatuses for automating a cell staining process.

Embodiments of the present disclosure provided herein are described by way of the following numbered alternatives:

1. An apparatus for performing multiplexed cytopathological staining, comprising:
a) a staining container configured to comprise an aqueous cell medium, staining reagents, washing reagents, and/or slide mounting medium and cells from a biological sample from a patient, and wherein the staining container is configured to perform alternating staining steps and washing steps to provide stained cells; and
b) an extraction container configured to receive used aqueous cell medium, used staining reagents, and/or used washing reagents from the staining container and permit removal of said used aqueous cell medium, used staining reagents, and/or used washing reagents;
wherein the staining container and the extraction container are operatively separated by a semi-permeable membrane that is permeable to the aqueous cell medium, staining reagents, washing reagents, and/or mounting medium but not permeable to the cells.

2. The apparatus of alternative 1, wherein the semi-permeable membrane comprises pores, the pores configured to permit liquid and small molecules to cross the semi-permeable membrane but does not permit cells to cross the semi-permeable membrane.

3. The apparatus of alternative 2, wherein each of the pores comprise a diameter that is 0.05, 0.1, 0.2, 0.22, 0.3, 0.4, 0.45, 0.5, 0.6, 0.7, 0.8, 0.9, 1, 3, 5, or 10 μm, or any pore diameter within a range defined by any two of the aforementioned values.

4. The apparatus of any one of alternatives 1-3, wherein the staining reagents comprise a cell morphological stain, an immunocytochemical stain, or a chromogenic in-situ hybridization stain, or any combination thereof.

5. The apparatus of alternative 4, wherein the cell morphological stain comprises Diff-Quik, Papanicolaou stain, Wright-Giemsa stain, hematoxylin/eosin stain, or any derivatives or modifications thereof.

6. The apparatus of any one of alternatives 1-5, wherein the membrane is configured to transfer the staining reagents of each staining step and washing reagents of each washing step in the staining container to the extraction container either by passive diffusion or when the extraction container is under a negative pressure relative to the staining container, optionally wherein an extraction pump exerts the negative pressure.

7. The apparatus of any one of alternatives 1-6, wherein the staining container and extraction container are configured to be separated or configured to be blocked with a shutter, which prevents or inhibits transfer of aqueous cell medium, staining reagents, and/or washing reagents across the semi-permeable membrane between the staining container and the extraction container.

8. The apparatus of any one of alternatives 1-7, further comprising a reagent supply that is configured to provide to the staining container the aqueous cell medium, staining reagents, washing reagents, and/or slide mounting medium to the staining container, optionally wherein the reagent supply is operatively linked to a reagent pump configured to move the aqueous cell medium, staining reagents, washing reagents, and/or slide mounting medium from the reagent supply to the staining container, optionally wherein the aqueous cell medium comprises the cells.

9. The apparatus of any one of alternatives 1-8, further comprising a sample removal channel configured to remove the stained cells e.g., for mounting, optionally wherein the stained cells are in the slide mounting medium and, optionally wherein the sample removal channel is configured to remove the stained cells with negative pressure.

10. A method of multiplexed cytopathological staining of cells from a biological sample from a patient, comprising staining the cells with one or more staining steps using the apparatus of any one of alternatives 1-9.

11. The method of alternative 10, wherein the staining steps comprise staining the cells with a cell morphological stain, immunocytochemical stain, or chromogenic in-situ hybridization stain, or any combination thereof.

12. The method of alternative 10 or 11, wherein the cell morphological stain comprises Diff-Quik, Papanicolaou stain, Wright-Giemsa stain, hematoxylin/eosin stain, or any derivatives or modifications thereof.

13. A pathology slide assembly comprising a pathology slide and a pathology coverslip, wherein the pathology slide and pathology coverslip are configured to be sealed together, the pathology slide and pathology coverslip defining an internal void accessible by an inlet port and an outlet port of the pathology slide assembly, wherein the internal void is configured to receive a suspension of cells from a biological sample from a patient through the inlet port and expel cell-depleted media through the outlet port.

14. The pathology slide assembly of alternative 13, wherein the thickness of the pathology slide assembly is compatible with a light microscope.

15. The pathology slide assembly of alternative 13 or 14, wherein the surface of the pathology slide defining the internal void comprises a cell-adhesive material, optionally an adhesive gel, protein coating, carbohydrate coating, or nanomaterial, configured to immobilize said cells.

16. The pathology slide assembly of any one of alternatives 13-15, wherein the internal void comprises a single, uniform reservoir.

17. The pathology slide assembly of any one of alternatives 13-15, wherein the pathology coverslip is configured to comprise one or more microfluidic channels, and the internal void comprises the negative space defined by the one or more microfluidic channels, wherein the one or more microfluidic channels is configured to permit passage of the cells.

18. The pathology slide assembly of any one of alternatives 13-17, wherein the surface of the pathology slide, or coverslip or both, preferably a surface of the slide defining the internal void, is nanoroughened, wherein the nanoroughened surface enhances capture of the cells in the suspension.

19. The pathology slide assembly of any one of alternatives 13-18, wherein the inlet port is configured to be operatively connected by a chaining channel to an outlet port of a second pathology slide assembly; and/or wherein the outlet port is configured to be operatively connected by a chaining channel to an inlet port of a third pathology slide assembly.

20. A plurality of pathology slide assemblies comprising two or more pathology slide assemblies of any one of alternatives 13-19, wherein the two or more pathology slide assemblies are configured to be consecutively chained through the inlet ports and outlet ports of each pathology slide assembly, such that the internal voids of the two or more pathology slide assemblies are in fluid communication to form a contiguous space, and wherein an exposed inlet port of one of the two or more pathology slide assemblies and an exposed outlet port of another one of the two or more pathology slide assemblies remain unchained to allow access to the contiguous space.

21. A method of mounting cells from a biological sample from a subject with the pathology slide assembly of any one of alternatives 13-19 or the plurality of pathology slide assemblies of alternative 20, comprising: flowing a suspension of the cells through:
a) the inlet port into the internal void of the pathology slide assembly; or
b) the exposed inlet port of the plurality of pathology slide assemblies into the contiguous space of the plurality of pathology slide assemblies; and
allowing the cells to settle and/or adhere to the surface of the pathology slide or pathology slides defining the internal void.

22. The method of alternative 21, further comprising flowing a washing reagent and/or a mounting medium through the inlet port into the internal void of the pathology slide assembly (or the exposed inlet port into the contiguous space of the plurality of pathology slide assemblies) to replace a liquid component of the suspension of the cells, wherein the cells are retained in the internal void, and wherein the liquid component of the suspension is expelled through the outlet port (or the exposed outlet port of the plurality of pathology slide assemblies).

23. The method of alternative 21 or 22, further comprising imaging the cells that are settled and/or adhered to the surface of the pathology slide or pathology slides by light microscopy.

24. The method of any one of alternatives 21-23, wherein the cells are fixed and/or permeabilized.

25. The method of any one of alternatives 21-24, wherein the cells are stained by a cell morphological stain, immunocytochemical stain, or chromogenic in-situ hybridization stain, or any combination thereof, optionally with the apparatus of any one of alternatives 1-9 or by the method of any one of alternatives 10-12.

26. A combined staining apparatus comprising the apparatus of any one of alternatives 1-9 and either:
a) the pathology slide assembly of any one of alternatives 13-19, wherein the sample removal channel of the apparatus is configured to be operatively connected to the inlet port of the pathology slide assembly; or
b) the plurality of pathology slide assemblies of alternative 20, wherein the sample removal channel of the apparatus is configured to be operatively connected to the exposed inlet port of the plurality of pathology slide assemblies.

27. The apparatus of any one of alternatives 1-9, the method of any one of alternatives 10-12, the pathology slide assembly of any one of alternatives 13-18, the method of any one of alternatives 19-23, or the combined staining apparatus of alternative 26, wherein the cells from the biological sample from the patient comprise atypical cells, optionally cancer cells.

28. The apparatus, method, pathology slide assembly, method, or combined staining apparatus of alternative 24, wherein the cells comprise urinary sediment cells.

29. The apparatus, method, pathology slide assembly, method, or combined staining apparatus of alternative 25, wherein the urinary sediment cells are stained for one or more bladder cancer specific biomarkers, optionally wherein the one or more bladder cancer specific biomarkers are selected from the group consisting of S100P, p63, M344, LDQ10, 19A211, GATA-3, Ki-67, p16, Her-2, PD-L1, CTLA4, CK-17, CK-20, nmp-22, bladder tumor antigen (BTA), hTERT, and mini-chromosome maintenance protein 5 (MCM5).

30. A combined staining apparatus comprising a sample entrance, visual inspection system, working condition indicator, control panel, glass slide entrance, mouse and keyboard.

31. The apparatus of alternative 30 further comprising a reagent dispensing module, staining chambers with porous membrane, shaker, vision inspection area, device to remove chamber wall device to transfer stained cells to glass slides, waste collection hole, and liquid waste collecting mechanism.

32. The apparatus of alternative 30, wherein the liquid waste collection system further comprises a vacuum.

33. The method of alternative 30, wherein the processing of a liquid sample to a stained pathology slide is automated e.g., in a closed system.

34. The method of alternative 31, wherein the sample processing comprises approximately three hours.

35. A staining chamber or vial having a removable cylinder wall, comprising:
a) an upper portion;
b) a porous membrane; and
c) a lower portion, wherein the lower portion is connected to an air-pump and a used liquid reagents reservoir, and wherein the upper portion is configured to be removably coupled to the lower portion;
wherein the porous membrane is positioned between the upper portion and the lower portion; and
wherein the upper portion comprises an overhanging lip that extends past the junction of the membrane and the lower portion and contacts a shelf of the lower portion.

36. The staining chamber or vial of alternative 35, wherein the porous membrane is round, or oval in shape, and up to 20 mm×20 mm in round shape, or 20 mm×40 mm in oval shape

37. The staining chamber or vial of alternative 35, further comprising a seal around a circumference of the lower portion above the shelf, the seal configured to contact a surface of the upper portion.

38. The staining chamber or vial of alternative 37, wherein the seal comprises plastic or rubber.

39. The staining chamber or vial of alternative 35, further comprising a protruding rim around the top of the upper portion.

40. The staining chamber or vial of alternative 39, wherein the protruding rim functions as the anchor to pull the staining chamber cylinder wall away and discard it after the staining process is complete.

41. The staining chamber or vial of alternative 40, wherein upon removal of the staining chamber cylinder wall, the stained cells will be exposed and subsequently pressed against the glass slides containing adhesive materials for the cells.

42. The staining chamber or vial of alternative 41, wherein the cell transfer process is also facilitated by blowing positive air pressure from under the porous membrane.

43. The staining chamber or vial of any one of alternatives 35-42, wherein the staining chamber is configured to allow used reagents to be aspirated downward to the lower portion and discarded, and wherein the upper portion is configured to receive new reagents.

44. The staining chamber or vial of any one of alternatives 35-43, wherein the staining chamber or vial is configured to expose stained cells upon removal of the upper portion.

45. A method of detecting bladder cancer from a biological sample from a subject, with the apparatus of any one of alternatives 30-32, the method comprising:
i. loading at least one cell-containing liquid sample into the apparatus,
ii. staining the at least one liquid sample,
iii. transferring the stained cells to a pathology slide,
iv. fixing the stained cells,
v. imaging the stained sample slide to detect analytes indicative of cancer biomarker expression and/or cytopathology.

46. The method of alternative 45, wherein the staining step comprises a combination of cytomorphological stains and staining for cancer biomarkers.

47. The method of alternative 45, wherein the steps of staining, transferring and fixing are performed by the apparatus.

48. The method of alternative 45, wherein the cells in the liquid sample comprise urinary sediment cells.

49. The method of alternative 45, wherein the staining step comprises a cell morphological stain comprising Diff-Quik, Papanicolaou stain, Wright-Giemsa stain, hematoxylin/eosin stain, or any derivatives or modifications thereof.

50. The method of alternative 45, wherein the staining step comprises staining for cancer biomarkers, wherein the cancer biomarkers comprise bladder cancer biomarkers, wherein the bladder cancer specific biomarkers are selected from the group consisting of S100P, p63, M344, LDQ10, 19A211, GATA-3, Ki-67, p16, Her-2, PD-L1, CTLA4, CK-17, CK-20, nmp-22, bladder tumor antigen (BTA), hTERT, and mini-chromosome maintenance protein 5 (MCM5).

51. The method of alternative 45, wherein the evaluation of the stained sample is performed using a light microscope or fluorescent microscope.

52. The method of alternative 45, wherein the cells are stained by a cell morphological stain, immunocytochemical stain, or chromogenic in-situ-hybridization stain, or any combination thereof.

53. A method of detecting bladder cancer from a biological sample from a subject, wherein the apparatus of any one of alternatives 30-32 further comprises the staining chamber or vial of any one of alternatives 35-44.

54. The apparatus of alternative 31, wherein the staining chamber with porous membrane is the staining chamber of alternatives 35-44.

55. An apparatus for performing multiplex cytopathological staining, comprising:
one or more staining chambers, each of the one or more staining chambers comprising a porous membrane, a surface of the porous membrane configured to receive cells;
a visual inspection system configured to determine completion of a staining process;
a reagent dispensing module configured to distribute reagents to the one or more staining chambers;
a shaker positioned below the one or more staining chambers; and
a transfer arm configured to move stained cells from the one or more staining chambers to one or more glass slides.

56. The apparatus of alternative 55, wherein the one or more staining chambers comprises an upper portion configured to contain the reagents and configured to be separated from the porous membrane and a lower portion of the staining chambers.

57. The apparatus of alternative 56, comprising a gripper configured to engage with the upper portion and remove the upper portion from the porous membrane and the lower portion.

58. The apparatus of alternative 57, the gripper configured to engage with a lip of the upper portion.

59. The apparatus of alternative 57 or 58, the gripper configured to move the upper portion into a waste collection hole.

60. The apparatus of any of alternatives 55 to 59, comprising a pump configured to generate a pressure below the porous membrane.

61. The apparatus of any of alternatives 55 to 60, comprising rails configured to convey the shaker and one or more staining chambers from a first location within the apparatus to a second location within the apparatus, the transfer arm configured to move stained cells from the porous membrane to the one or more glass slides when the one or more staining chambers are positioned at the second location.

62. The apparatus of any of alternative s 55 to 61, wherein the visual inspection system comprises a camera in electronic communication with a hardware processor, the camera configured to image at least a portion of the staining chamber, the hardware processor configured to determine completion of the staining process based at least in part on an image generated by the camera.

63. The apparatus of any of alternatives 55 to 62, comprising a liquid waste collector, the liquid waste collector in fluid communication with a lower portion of the one or more staining chambers, the lower portion of the one or more staining chambers opposite the surface of the porous membrane.

64. The apparatus of alternative 63, the liquid waste collector comprising a pump configured to generate a negative pressure within the lower portion of the one or more staining chambers.

### BRIEF DESCRIPTION OF THE DRAWINGS

In addition to the features described herein, additional features and variations will be readily apparent from the following descriptions of the drawings and exemplary embodiments. It is to be understood that these drawings depict embodiments and are not intended to be limiting in scope.

FIG. 1A-C depict embodiments of an exemplary cytopathological staining apparatus in a “vertical” format.

FIG. 1D-F depict embodiments of an exemplary cytopathological staining apparatus in a “horizontal” format.

FIG. 2A depicts an embodiment of an exemplary pathology slide, which can be used with embodiments of a pathology coverslip as depicted in FIG. 2B or otherwise disclosed herein.

FIG. 2B depicts embodiments of an exemplary pathology coverslip, which can be used with embodiments of a pathology slide as depicted in FIG. 2A or otherwise disclosed herein.

FIG. 2C depicts embodiments of exemplary pathology slide assemblies comprised of an embodiment of the pathology slide and an embodiment of the pathology coverslip as depicted in FIG. 2A-B or otherwise disclosed herein.

FIG. 2D depicts embodiments of a profile view and enlarged cross section view of the exemplary pathology slide assemblies depicted in FIG. 2C or otherwise disclosed herein.

FIG. 3A-B depict embodiments of chaining of two or more of any of the exemplary pathology slide assemblies disclosed herein. As shown in FIG. 3B, any combination of the same or different exemplary pathology slide assemblies may be chained together.

FIG. 4A depicts embodiments of an exemplary cytopathological staining apparatus in a “vertical” format operatively linked through a sample removal channel to an exemplary pathology slide assembly as disclosed herein.

FIG. 4B depicts embodiments of an exemplary cytopathological staining apparatus in a “horizontal” format operatively linked through a sample removal channel to an exemplary pathology slide assembly as disclosed herein.

FIG. 5A-B depict embodiments of an exemplary alternative staining chamber in an assembled format.

FIG. 6A-B depict cross sections of embodiments of an exemplary alternative staining chamber in a disassembled format.

FIG. 7A-B depict cross sections of embodiments of an exemplary alternative staining chamber in a disassembled format with increased detail regarding the junction between the upper and lower portions.

FIG. 8 depicts a cross section of embodiments of an exemplary alternative staining chamber in an assembled format with increased detail regarding the junction between the upper and lower portions.

FIG. 9 depicts an external view of the staining apparatus.

FIG. 10 depicts an internal view of the staining apparatus showing the reagent dispensing module, staining chambers, and shaker.

FIG. 11 depicts an internal view of the staining apparatus showing the vision inspection area.

FIG. 12 depicts an internal view of the staining apparatus showing the device to remove the chamber wall.

FIG. 13 depicts an internal view of the staining apparatus showing the device to transfer stained cells to slides.

FIG. 14 depicts an internal view of the staining apparatus showing the waste collection hole/reservoir.

FIG. 15 depicts an internal view of the staining apparatus showing the liquid waste collection mechanism.

### DETAILED DESCRIPTION

Disclosed herein are apparatuses and methods of use thereof for multiple staining and cytological slide preparation of biological samples, for example for the cytopathological diagnosis of a disease involving atypicality of cells, including but not limited to cancer. The approaches provided herein include staining cells from biological samples in suspension, thereby ensuring even and consistent staining for analysis. Apparatuses provided for herein may include a membrane permeable to reagents and staining fluids but impermeable to cells. The apparatuses and methods of use disclosed herein may also involve automation, advantageously limiting variability in sample preparation due to human error.

Cytopathology relates to the examination of individual cells from a biological sample of a patient in order to assess morphological features and potential atypicality of the cells, such as for the diagnosis of various diseases. This may be useful for the diagnosis of cancer, as cancer cells exhibit atypical properties such as uncontrolled division, abnormal genomes and enlarged nuclei, variation in cell morphology, arrangement and internal pH, and significant changes to functional phenotype such as expression of cell markers and other proteins.

Conventional staining methods for cytopathology include Papanicolaou stain (Pap stain), Wright-Giemsa stain, and Diff-Quik stain. Diff-Quik, which is presently the most utilized stain for daily cytopathologic practice and recommended by the World Health Organization (WHO), usually contains a xanthene dye (e.g., Eosin Y), and a thiazine dye (e.g., methylene blue or azure A). Such dyes can highlight nuclear features, for example the shape and size of nuclei and nucleoli; the density of chromatin; cytoplasmic elements such as mucins, fat droplets and neurosecretory granules; and cell membrane features such as membrane grooves, projections, and vacuoles. Extracellular substances, such as free mucin, colloids, and ground substance, can also be stained. These features may be useful for making cytopathologic diagnoses.

Staining may be performed after cells are fixed and affixed to slides. This may result in staining “blind spots,” where surfaces of cells attached to the slide surface may not be properly stained and/or stain may be trapped between surfaces despite washing steps, resulting in so-called “edge effects”. These issues all may impact the accuracy of cytopathological detection.

Furthermore, these conventional approaches may only provide low-confidence information. For cases where isolation of target cells may be difficult or results in a low number of target cells in a biological sample (such as in the case for urinary sediment cells for bladder cancer diagnosis), the low number of cells for examination may impact confident atypical cell diagnosis. In order to improve the success rate (e.g., reduce false negatives and false positives), conventional cytomorphologic stains may be combined with biomarker detection using approaches such as immunocytochemistry and chromogenic in-situ hybridization. The identification of biomarkers on cells also characterized as atypical can significantly improve positive diagnosis by the pathologist, even with patient samples with low number of cells. However, the sequential processing of biological samples for both morphological and biomarker staining requires care to limit loss of cells and avoid disruption of the starting cell morphologies during each step.

### Multiple Staining of Urinary Sediment Cells for Detection of Bladder Cancer

Urine cytology is a process of evaluating urinary sediment cells (and constituent malignant cells) on glass slides by pathologists, who examine the cytopathologic features of every individual cell under conventional light microscopy. It is routinely used in clinical practice as a noninvasive test for bladder cancer. Bladder cancer can be categorized as either low-grade or high-grade. Low-grade tumors are characterized by cancerous cells that proliferate slowly and cytomorphologically resemble normal urothelial and other bladder cells. While low-grade bladder tumors do not often progress to more malignant and invasive tumors than high-grade bladder cancer, early detection and maintenance of low-grade tumors may be desirable, as the presence of low-grade tumors may indicate an individual's proclivity for developing advanced bladder cancer. High-grade tumors may include cells that proliferate rapidly, invade the surrounding bladder muscle, and eventually metastasize. While there are approved pathological methods to detect high-grade bladder tumors, the detection of low-grade tumors may be difficult due to their similarity to normal bladder cells. Accordingly, while urine cytology may be highly effective for the detection of high-grade and high-stage bladder disease with high sensitivity and specificity, it proves relatively ineffective as a tool to detect low-grade malignancy with reported sensitivity ranging only around 4% to 31% for the detection of low-grade tumors.

In conventional methods, urinary sediment cells are obtained through 20-25 mL of urine sample by centrifugation. The sediment cells are then prepared as a thin layer of cells on pathology glass slides and stained with clinically approved methods to demonstrate the cellular morphologic features for pathologist to make diagnoses.

The bladder cancer grade describes how much cancer cells look like healthy cells when viewed under a microscope after staining. However, due to their relatively normal appearance, low grade bladder cancer cells may be miscategorized as normal cells, or categorized as atypical or suspicious cells without a definitive diagnosis. Because the apparent deficiencies and exceedingly high false negative rate for low-grade bladder tumors, other technologies have been explored to aid urine cytology. Bladder tumor-specific biomarker expression on exfoliated malignant cells has gained much attention for this purpose. Two main technique platforms have been developed to meet this growing need:
1) Quantification of bladder tumor specific biomarker protein concentrations in urine samples.
2) Detection of biomarker expression in urine sediment cells by fluorescent techniques, namely immunofluorescent staining (IF) and fluorescent in-situ hybridization (FISH).

The U.S. FDA so far as approved six products to detect bladder tumors using urinary samples. These products include BTA stat, BTATRAK, NMP22 BC, NMP22 BladderChek, ImmunoCyt/uCyt, and UroVysion. However, these tests have not been considered superior to urine cytology due to their suboptimal sensitivity and specificity, and have not been widely adopted by urologists. Four of the products (BTA stat, BTATRAK, NMP22 BC, NMP22 BladderChek) measure the protein concentration of bladder cancer specific biomarkers, while ImmunoCyt/uCyt and UroVysion detect the biomarkers by immunofluorescence. None of these tests can provide a detailed cellular morphology that is qualified for pathologic diagnosis. Although immunofluorescent stains can delineate the overall shape and size of targeted cells, they are neither sufficient nor qualified for a morphologic diagnosis by a pathologist. Accordingly, no detailed morphologic or cytopathologic information that is qualified for pathologic diagnosis can be generated from these assays.

Furthermore, the FDA-approved techniques exhibit significant inter-observer discrepancies in sensitivity and specificity, potentially impacting the precision of the tests. This may include a large number of false positive results from benign or alternative causes including infection, stones, hematuria, and recent instrumentation of the urinary system. Widespread use of these assays has also been limited due to the requirement of special laboratory equipment (such as darkrooms and expensive fluorescent microscopes) and experienced readers to interpret test results.

A combination of cytomorphological and cancer biomarker assessment overcomes these limitations and provides greater confidence in the identification of both low-grade and high-grade bladder cancer in patient samples. These approaches involve staining the cells in suspension rather than following affixion to slides, which limits undesirable staining artifacts. Methods for this combined approach are contemplated in Chinese Patent Applications CN202010468262.6 and CN202010467313.3, each of which are hereby expressly incorporated by reference in its entirety. The methods provided therein are compatible with the apparatuses and methods disclosed herein, which can be operated or performed manually, or with automation to further improve consistency in sample preparation.

Exemplary diagnostic cytomorphologic stains that can be used with the apparatuses and methods disclosed herein for the diagnosis of bladder cancer may include, but are not limited to Diff-Quik stain, Papanicolaou stain, Wright-Giemsa stain, hematoxylin/eosin stain, or a derivative or modification thereof. Exemplary bladder cancer specific biomarker that can be used for immunocytochemistry or chromogenic in-situ hybridization staining for the apparatuses and methods disclosed herein may include, but are not limited to, S100P, p63, M344, LDQ10, 19A211, GATA-3, Ki-67, p16, Her-2, PD-L1, CTLA4, CK-17, CK-20, nmp-22, BTA, hTERT, or MCM5.

### Definitions

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Unless defined otherwise, technical and scientific terms used herein have the same meaning as commonly understood when read in light of the instant disclosure by one of ordinary skill in the art to which the present disclosure belongs. For purposes of the present disclosure, the following terms are explained below.

The disclosure herein generally uses affirmative language to describe the numerous embodiments. The disclosure also includes embodiments in which subject matter is excluded, in full or in part, such as substances or materials, method steps and conditions, protocols, or procedures.

The articles “a” and “an” are used herein to refer to one or to more than one (for example, at least one) of the grammatical object of the article. By way of example, “an element” means one element or more than one element.

By “about” is meant a quantity, level, value, number, frequency, percentage, dimension, size, amount, weight or length that varies by as much as 10% to a reference quantity, level, value, number, frequency, percentage, dimension, size, amount, weight or length.

Throughout this specification, unless the context requires otherwise, the words “comprise,” “comprises,” and “comprising” will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The terms “individual,” “subject,” or “patient” as used herein have their plain and ordinary meaning as understood in light of the specification, and mean a human or a non-human mammal, e.g., a dog, a cat, a mouse, a rat, a cow, a sheep, a pig, a goat, a non-human primate, or a bird, e.g., a chicken, as well as any other vertebrate or invertebrate. The term “mammal” is used in its usual biological sense. Thus, it specifically includes, but is not limited to, primates, including simians (chimpanzees, apes, monkeys) and humans, cattle, horses, sheep, goats, swine, rabbits, dogs, cats, rodents, rats, mice, or guinea pigs, or the like.

The terms “effective amount” or “effective dose” as used herein have their plain and ordinary meaning as understood in light of the specification, and refer to that amount of a recited composition or compound that results in an observable effect. Actual dosage levels of active ingredients in an active composition of the presently disclosed subject matter can be varied so as to administer an amount of the active composition or compound that is effective to achieve the desired response for a particular subject and/or application. The selected dosage level will depend upon a variety of factors including, but not limited to, the activity of the composition, formulation, route of administration, combination with other drugs or treatments, severity of the condition being treated, and the physical condition and prior medical history of the subject being treated. In some embodiments, a minimal dose is administered, and dose is escalated in the absence of dose-limiting toxicity to a minimally effective amount. Determination and adjustment of an effective dose, as well as evaluation of when and how to make such adjustments, are contemplated herein.

The terms “function” and “functional” as used herein have their plain and ordinary meaning as understood in light of the specification, and refer to a biological, enzymatic, or therapeutic function.

The term “inhibit” as used herein has its plain and ordinary meaning as understood in light of the specification, and may refer to the reduction or prevention of a biological activity. The reduction can be by a percentage that is, is about, is at least, is at least about, is not more than, or is not more than about, 10%, 20%, 30%, 40%, 50%, 60%, 70%, 80%, 90%, or 100%, or an amount that is within a range defined by any two of the aforementioned values. As used herein, the term “delay” has its plain and ordinary meaning as understood in light of the specification, and refers to a slowing, postponement, or deferment of a biological event, to a time which is later than would otherwise be expected. The delay can be a delay of a percentage that is, is about, is at least, is at least about, is not more than, or is not more than about, 0%, 10%, 20%, 30%, 40%, 50%, 60%, 70%, 80%, 90%, 100%, or an amount within a range defined by any two of the aforementioned values. The terms inhibit and delay may not necessarily indicate a 100% inhibition or delay. A partial inhibition or delay may be realized.

As used herein, the term “isolated” has its plain and ordinary meaning as understood in light of the specification, and refers to a substance and/or entity that has been (1) separated from at least some of the components with which it was associated when initially produced (whether in nature and/or in an experimental setting), and/or (2) produced, prepared, and/or manufactured by the hand of man. Isolated substances and/or entities may be separated from equal to, about, at least, at least about, not more than, or not more than about, 10%, about 20%, about 30%, about 40%, about 50%, about 60%, about 70%, about 80%, about 90%, about 95%, about 98%, about 99%, substantially 100%, or 100% of the other components with which they were initially associated (or ranges including and/or spanning the aforementioned values). In some embodiments, isolated agents are, are about, are at least, are at least about, are not more than, or are not more than about 80%, about 85%, about 90%, about 91%, about 92%, about 93%, about 94%, about 95%, about 96%, about 97%, about 98%, about 99%, substantially 100%, or 100% pure (or ranges including and/or spanning the aforementioned values). As used herein, a substance that is “isolated” may be “pure” (e.g., substantially free of other components). As used herein, the term “isolated cell” may refer to a cell not contained in a multi-cellular organism or tissue.

As used herein, “in vivo” is given its plain and ordinary meaning as understood in light of the specification and refers to the performance of a method inside living organisms, usually animals, mammals, including humans, and plants, as opposed to a tissue extract or dead organism.

As used herein, “ex vivo” is given its plain and ordinary meaning as understood in light of the specification and refers to the performance of a method outside a living organism with little alteration of natural conditions.

As used herein, “in vitro” is given its plain and ordinary meaning as understood in light of the specification and refers to the performance of a method outside of biological conditions, e.g., in a petri dish or test tube.

The terms “nucleic acid” or “nucleic acid molecule” as used herein have their plain and ordinary meaning as understood in light of the specification, and refer to polynucleotides, such as deoxyribonucleic acid (DNA) or ribonucleic acid (RNA), oligonucleotides, those that appear in a cell naturally, fragments generated by the polymerase chain reaction (PCR), and fragments generated by any of ligation, scission, endonuclease action, and exonuclease action. Nucleic acid molecules can be composed of monomers that are naturally-occurring nucleotides (such as DNA and RNA), or analogs of naturally-occurring nucleotides (e.g., enantiomeric forms of naturally-occurring nucleotides), or a combination of both. Modified nucleotides can have alterations in sugar moieties and/or in pyrimidine or purine base moieties. Sugar modifications include, for example, replacement of one or more hydroxyl groups with halogens, alkyl groups, amines, and azido groups, or sugars can be functionalized as ethers or esters. Moreover, the entire sugar moiety can be replaced with sterically and electronically similar structures, such as aza-sugars and carbocyclic sugar analogs. Examples of modifications in a base moiety include alkylated purines and pyrimidines, acylated purines or pyrimidines, or other well-known heterocyclic substitutes. Nucleic acid monomers can be linked by phosphodiester bonds or analogs of such linkages. Analogs of phosphodiester linkages include phosphorothioate, phosphorodithioate, phosphoroselenoate, phosphorodiselenoate, phosphoroanilothioate, phosphoranilidate, or phosphoramidate. The term “nucleic acid molecule” also includes so-called “peptide nucleic acids,” which comprise naturally-occurring or modified nucleic acid bases attached to a polyamide backbone. Nucleic acids can be either single stranded or double stranded. “Oligonucleotide” can be used interchangeable with nucleic acid and can refer to either double stranded or single stranded DNA or RNA. A nucleic acid or nucleic acids can be contained in a nucleic acid vector or nucleic acid construct (e.g., plasmid, virus, retrovirus, lentivirus, bacteriophage, cosmid, fosmid, phagemid, bacterial artificial chromosome (BAC), yeast artificial chromosome (YAC), or human artificial chromosome (HAC)) that can be used for amplification and/or expression of the nucleic acid or nucleic acids in various biological systems. Typically, the vector or construct will also contain elements including but not limited to promoters, enhancers, terminators, inducers, ribosome binding sites, translation initiation sites, start codons, stop codons, polyadenylation signals, origins of replication, cloning sites, multiple cloning sites, restriction enzyme sites, epitopes, reporter genes, selection markers, antibiotic selection markers, targeting sequences, peptide purification tags, or accessory genes, or any combination thereof.

A nucleic acid or nucleic acid molecule can comprise one or more sequences encoding different peptides, polypeptides, or proteins. These one or more sequences can be joined in the same nucleic acid or nucleic acid molecule adjacently, or with extra nucleic acids in between, e.g. linkers, repeats or restriction enzyme sites, or any other sequence that is, is about, is at least, is at least about, is not more than, or is not more than about, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, or 300 bases long, or any length in a range defined by any two of the aforementioned values. The term “downstream” on a nucleic acid as used herein has its plain and ordinary meaning as understood in light of the specification and refers to a sequence being after 3′-end of a previous sequence, on the strand containing the encoding sequence (sense strand) if the nucleic acid is double stranded. The term “upstream” on a nucleic acid as used herein has its plain and ordinary meaning as understood in light of the specification and refers to a sequence being before 5′-end of a subsequent sequence, on the strand containing the encoding sequence (sense strand) if the nucleic acid is double stranded. The term “grouped” on a nucleic acid as used herein has its plain and ordinary meaning as understood in light of the specification and refers to two or more sequences that occur in proximity either directly or with extra nucleic acids in between, e.g. linkers, repeats, or restriction enzyme sites, or any other sequence that is, is about, is at least, is at least about, is not more than, or is not more than about, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, or 300 bases long, or any length in a range defined by any two of the aforementioned values, but generally not with a sequence in between that encodes for a functioning or catalytic polypeptide, protein, or protein domain.

The nucleic acids described herein comprise nucleobases. Primary, canonical, natural, or unmodified bases are adenine, cytosine, guanine, thymine, and uracil. Other nucleobases include but are not limited to purines, pyrimidines, modified nucleobases, 5-methylcytosine, pseudouridine, dihydrouridine, inosine, 7-methylguanosine, hypoxanthine, xanthine, 5,6-dihydrouracil, 5-hydroxymethylcytosine, 5-bromouracil, isoguanine, isocytosine, aminoallyl bases, dye-labeled bases, fluorescent bases, or biotin-labeled bases.

The terms “peptide,” “polypeptide,” and “protein” as used herein have their plain and ordinary meaning as understood in light of the specification and refer to macromolecules comprised of amino acids linked by peptide bonds. The numerous functions of peptides, polypeptides, and proteins are known in the art, and include but are not limited to enzymes, structure, transport, defense, hormones, or signaling. Peptides, polypeptides, and proteins are often, but not always, produced biologically by a ribosomal complex using a nucleic acid template, although chemical syntheses are also available. By manipulating the nucleic acid template, peptide, polypeptide, and protein mutations such as substitutions, deletions, truncations, additions, duplications, or fusions of more than one peptide, polypeptide, or protein can be performed. These fusions of more than one peptide, polypeptide, or protein can be joined in the same molecule adjacently, or with extra amino acids in between, e.g. linkers, repeats, epitopes, or tags, or any other sequence that is, is about, is at least, is at least about, is not more than, or is not more than about, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 150, 200, or 300 bases long, or any length in a range defined by any two of the aforementioned values. The term “downstream” on a polypeptide as used herein has its plain and ordinary meaning as understood in light of the specification and refers to a sequence being after the C-terminus of a previous sequence. The term “upstream” on a polypeptide as used herein has its plain and ordinary meaning as understood in light of the specification and refers to a sequence being before the N-terminus of a subsequent sequence.

The term “% w/w” or “% wt/wt” as used herein has its plain and ordinary meaning as understood in light of the specification and refers to a percentage expressed in terms of the weight of the ingredient or agent over the total weight of the composition multiplied by 100. The term “% v/v” or “% vol/vol” as used herein has its plain and ordinary meaning as understood in the light of the specification and refers to a percentage expressed in terms of the liquid volume of the compound, substance, ingredient, or agent over the total liquid volume of the composition multiplied by 100.

The term “urinary exfoliated cells” as used herein refer to the small number of urothelial cells and other cells associated with the urinary tract, including potentially cancerous cells, may be excreted during urine evacuation. Analyzing these excreted cells (e.g., cancerous cells, red blood cells, white blood cells, or bacteria) from urine samples provides a non-invasive method of assessing the health of an individual. However, the concentration of these urinary exfoliated cells may be very low, and therefore enrichment may be desirable and/or necessary. This can be accomplished by centrifugation, such that the constituent cells can be compacted into a cell pellet (termed “urinary sediment cells”), which can be resuspended and used for downstream processes.

Specific cellular targets in a sample can be detected and stained. These specific cellular targets may be any biological component, including but not limited to proteins or nucleic acids. Two approaches are immunohistochemistry (immunocytochemistry), which use antibodies to detect proteins (or any other epitope able to be bound by antibodies), and in-situ hybridization (fluorescent, chromogenic, or otherwise), which use nucleic acid probes to hybridize and detect nucleic acids such as DNA or RNA. Immunocytochemistry and chromogenic in-situ hybridization specific for bladder cancer specific biomarkers have been disclosed herein in some embodiments. In particular, chromogenic techniques which enzymatically convert chromogens to colored precipitates can be used due to the ease of detection using conventional light microscopy. However, it is envisioned that alternative biomarker-specific stains and other biomarkers can be substituted by one skilled in the art.

Conventional immunocytochemistry may be performed on glass slides. The cellular or tissue sample on the slides can be incubated with a specific primary antibody for a protein target. After extensive washing to remove the primary antibody, the secondary antibody with conjugated chromogenic enzyme can be incubated on the slides. Then, the corresponding chromogen is added to the slides, and positive signals can be generated by chromogenic precipitation through catalytic reactions by the conjugated chromogenic enzyme. The signals on the slides can be evaluated by light microscopy.

Conventional chromogenic in-situ hybridization may be performed on glass slides. The cellular or tissue sample on the slides can be incubated with a specific nucleic acid probe that hybridizes with a nucleic acid target. After extensive washing to remove the nucleic acid probe, secondary reagents conjugated with chromogenic enzyme can be sequentially incubated on the slides. Then, the corresponding chromogen can be added to the slides, and positive signals can be generated by chromogenic precipitation through catalytic reactions by the conjugated chromogenic enzyme. The signals on the slides can be evaluated by light microscopy.

Immunocytochemistry may use protein antibodies whereas chromogenic in-situ hybridization may use nucleic acid probes as their respective primary reagents. The signal production and evaluation of each of the two approaches may be similar.

The term “cell morphological stain” as used herein refers to the staining process using a dye or a mixture of dyes which color cells and other biological material in a general manner (contrasting with immunocytochemistry or chromogenic in-situ hybridization stains which target a specific component). Cell morphological stains are commonly used to improve contrast of cells under conventional light microscopy and to provide distinguishable detail regarding cell morphology for cytopathological determination. Examples of cell morphological stains include Diff-Quik, Papanicolaou stain, Wright-Giemsa stain, and hematoxylin/eosin stain. It is envisioned that derivatives and modifications of known cell morphological stains may be used for certain desirable properties, provided that the chemical dyes, which provide the color are maintained or substituted.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described herein without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The term “e.g.” is understood to mean “for example” and is therefore a non-limiting.

It will be understood by those within the art that, in general, terms used herein, and especially in the appended claims (e.g., bodies of the appended claims) are generally intended as “open” terms (e.g., the term “including” is typically interpreted as “including but not limited to,” the term “having” is typically interpreted as “having at least,” the term “includes” is typically interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases is typically construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” is typically interpreted to mean “at least one” or “one or more”); the same holds true for the use of definite articles used to introduce claim recitations. In addition, even if a specific number of an introduced claim recitation is explicitly recited, those skilled in the art will recognize that such recitation is typically interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, is typically understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed herein. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references cited herein, including but not limited to published and unpublished applications, patents, and literature references, are incorporated herein by reference for any particular disclosure referenced herein and in their entirety, and are hereby made a part of this specification. To the extent publications and patents or patent applications incorporated by reference contradict the disclosure contained in the specification, the specification is intended to supersede and/or take precedence over any such contradictory material.

### Apparatuses for Multiplexed Cytopathological Staining

Disclosed herein are apparatuses for performing multiplexed cytopathological staining. Generally, these apparatuses involve the use of a single staining chamber where cells from a biological sample can be processed through multiple staining and washing steps and collected in a final collection step for further manipulation (e.g., mounting on a microscope slide for visualization). This enables a “one-pot” multiplexed staining procedure that eliminates the need for alternative approaches, such as centrifugation for cell collection and removal of used staining and washing reagents. A “one-pot” procedure may be advantageous for biological samples containing a low percentage of atypical cells and/or a low total number of cells, such as in the case of urinary sediment cells for the diagnosis of bladder cancer. Furthermore, apparatuses in accordance with the present disclosure may automate the multiple staining and washing steps, which may reduce sample processing variance and improve reliability for cytopathological observation.

In some embodiments, the apparatus comprises: a) a staining container that can to comprise an aqueous cell medium, staining reagents, washing reagents, and/or slide mounting medium and cells from a biological sample from a patient and b) an extraction container configured to receive used aqueous cell medium, used staining reagents, and/or used washing reagents and permit removal of said used aqueous cell medium, used staining reagents, and/or used washing reagents. In some embodiments, the staining container contains one or more aqueous media, staining reagents, washing reagents, and/or slide mounting medium. In some embodiments, the cells may be resuspended in a series of the aqueous cell medium, staining reagents, washing reagents, and/or slide mounting medium. In some embodiments, the extraction container may be capable of containing or configured to contain a series of used aqueous cell medium, used staining reagents, and/or used washing reagents. In some embodiments, the staining container and the extraction container may be operatively separated by a semi-permeable membrane, which can be permeable to the aqueous cell medium, staining reagents, washing reagents, and/or mounting medium but is not permeable to the cells, such that the cells may be retained in the staining container. In some embodiments, the staining container is configured to perform alternating staining steps and washing steps to provide stained cells. In some embodiments, the cells undergo a series of alternating staining steps and washing steps in the staining container, thereby providing stained cells. In some embodiments, the staining reagents of each staining step and washing reagents of each washing step in the staining container, once used, can be extracted into the extraction container. In some embodiments, the used staining reagents and used washing reagents can be removed from the extraction container.

In some embodiments, the semi-permeable membrane includes pores that permit liquid and any sufficiently small molecules to cross the membrane but does not permit cells to cross the membrane. In some embodiments, the pores may each have a diameter of 0.05, 0.1, 0.2, 0.22, 0.3, 0.4, 0.45, 0.5, 0.6, 0.7, 0.8, 0.9, 1, 3, 5, or 10 μm, or any diameter within a range defined by any two of the aforementioned values.

In some embodiments, the staining steps performed in the apparatus comprise staining with a cell morphological stain, immunocytochemical stain, or chromogenic in-situ hybridization stain, or any combination thereof. In some embodiments, the cell morphological stain comprises Diff-Quik, Papanicolaou stain, Wright-Giemsa stain, hematoxylin/eosin stain, or any derivatives, combinations, or modifications thereof.

In some embodiments, the staining reagents of each staining step and washing reagents of each washing step in the staining container can be extracted into the extraction container either by passive diffusion or by exerting negative pressure in the extraction container to drive the staining reagents and washing reagents in the staining container across the semi-permeable membrane into the extraction container. In some embodiments, the apparatus further comprises an extraction pump. In some embodiments, the extraction pump exerts the negative pressure on the extraction container relative to the staining container. In some embodiments, the staining container and extraction container can be physically separated or can be blocked with a shutter, which may prevent, inhibit, and/or reduce transfer of aqueous cell medium, staining reagents, and/or washing reagents across the semi-permeable membrane between the staining container and the extraction container.

In some embodiments, the apparatus further comprises a reagent supply that may be capable of providing or configured to provide the aqueous cell medium, staining reagents, washing reagents, and/or slide mounting medium to the staining container. In some embodiments, the apparatus further comprises a reagent pump. In some embodiments, the reagent supply may be operatively linked to a reagent pump configured to provide mechanical force to allow the reagent supply to provide the aqueous cell medium, staining reagents, washing reagents, and/or slide mounting medium. In some embodiments, the aqueous cell medium comprises the cells for the initial operation of the apparatus.

In some embodiments, the apparatus further comprises a sample removal channel that may be capable of removing or configured to remove the stained cells e.g., for mounting. In some embodiments, after final operation of the apparatus, the stained cells may be in the slide mounting medium. In some embodiments, the stained cells can be removed manually (e.g., by a pipette or syringe), or by exerting negative pressure through the sample removal channel. In some embodiments, the sample removal channel can remove the stained cells with negative pressure.

In some embodiments, the apparatus may be modified from a cell sample and slide preparation system, such as a ThinPrep 2000 system.

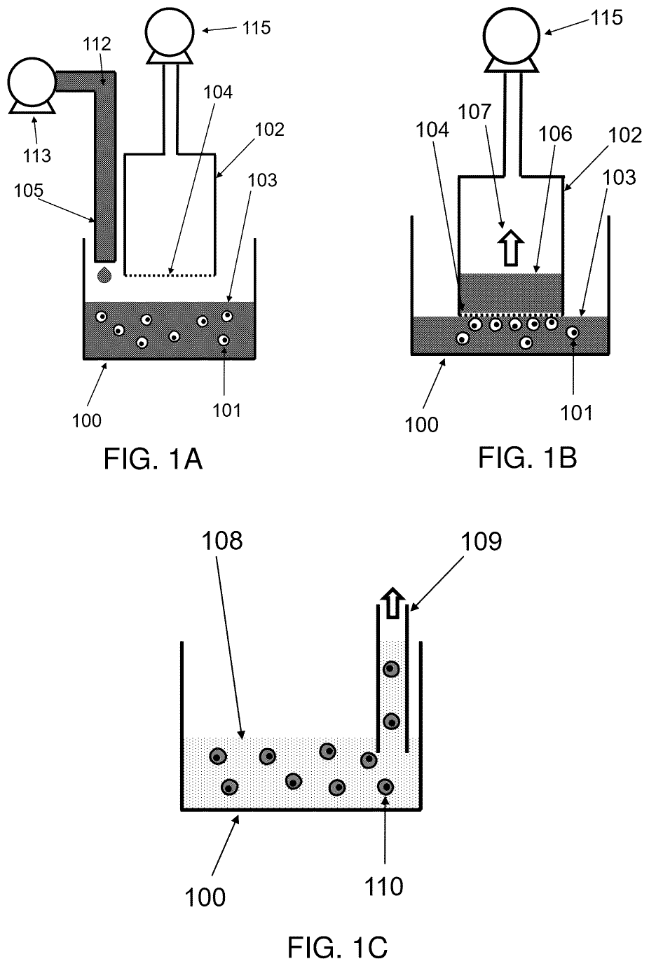

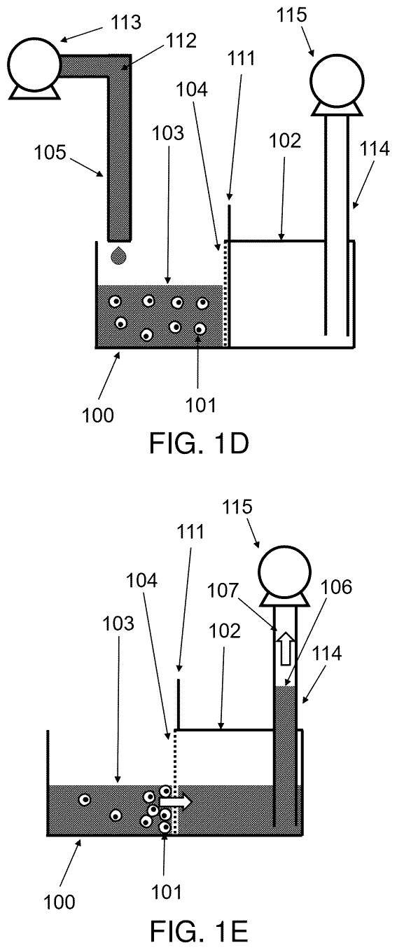

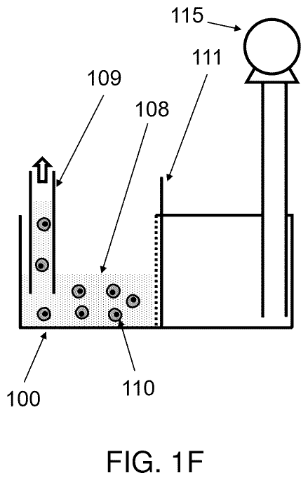

A non-limiting embodiment of an apparatus for performing multiplexed cytopathological staining in a “vertical” configuration is depicted in FIG. 1A-C.

An exemplary apparatus is shown in FIG. 1A. A staining container 100 is provided in which cells 101, isolated and/or purified from a biological sample from a patient, may be contained in a suspension in a compatible liquid medium 103.

In some embodiments, the staining container 100 may be a container with an opening and inner volume appropriate to contain the cells 101 and liquid medium 103. In some embodiments, the staining container 100 may include a bio-inert material, such as plastic, glass, quartz, steel, titanium, ceramic, alumina, zirconia, or other materials commonly used in cell culture. In some embodiments, the staining container 100 may be a tube, cylindrical tube, square tube, cuvette, dish, plate or other container that can be used in cell culture. In some embodiments, the staining container 100 may be optically clear, transparent, or configured to permit visualization of the contents in the container. In some embodiments, the staining container 100 may be compatible with a holder that can keep the staining container 100 stationary until removed from the holder.

In some embodiments, the cells 101 isolated and/or purified from a biological sample from a patient may be fixed and/or permeabilized prior to addition to the staining container 100. In some embodiments, the cells 101 may be fixed and/or permeabilized in the staining container 100 prior to operating the apparatus. In some embodiments, the cells 101 may be fixed and/or permeabilized in the staining container 100 by operation of the apparatus.

As depicted in FIG. 1A, also provided in the exemplary apparatus is an extraction container 102 with two open ends, where one end may be fitted with a semi-permeable membrane 104 that may be permeable to the liquid medium 103 (and small molecules, such as proteins, antibodies, nucleic acids, or small molecule stains) but may not be permeable to the cells 101. In some embodiments, the extraction container 102 can fit within the inner volume of the staining container 100. In some embodiments, the extraction container 102 may include a bio-inert material, such as plastic, glass, quartz, steel, titanium, ceramic, alumina, zirconia, or other materials commonly used in cell culture. In some embodiments, the extraction container 102 may be a tube, cylindrical tube, square tube, or other shape able to fit within the inner volume of the staining container 100. In some embodiments, the extraction container 102 may be optically clear, transparent, or configured to permit visualization of the contents of the container. In some embodiments, the other end (i.e., the end not fitted with the semi-permeable membrane 104) may be operatively connected to an extraction pump 115, e.g., an air pump, that can provide negative pressure 107, thereby permitting extraction of either atmospheric gases from the staining container 100 or the liquid medium 103 across the semi-permeable membrane 104. In some embodiments, the extraction pump 115 can also provide positive pressure, thereby permitting expulsion of the contents of the extraction container 102 into the staining container 100 or to a separate location (e.g., a waste container), across the semi-permeable membrane 104. Some embodiments may optionally exclude the extraction pump 115, and the contents of the extraction container 102 may be manipulated manually.

In some embodiments, the extraction container 102 can be manipulated such that its position respective to the staining container 100 can be moved. In some embodiments, the extraction container 102 can be moved such that 1) the extraction container 102 and the semi-permeable membrane 104 is not submerged in the liquid medium 103, or 2) the semi-permeable membrane 104 and at least a portion of the extraction container 102 most proximal to the semi-permeable membrane 104 (i.e., the part of the extraction container 102 that may be fitted with the semi-permeable membrane 104) can be submerged within the liquid medium 103. In some embodiments, the extraction container 102 can be moved such that the entire extraction container 102 and semi-permeable membrane 104 is not within the inner volume of the staining container 101. In some embodiments, the extraction container 102 may be manipulated manually, or manipulated with a motor.

In some embodiments, the semi-permeable membrane 104 comprises pores that permits liquid and any sufficiently small molecules to cross the membrane but does not permit cells to cross the membrane. In some embodiments, the pores comprise a diameter of 0.05, 0.1, 0.2, 0.22, 0.3, 0.4, 0.45, 0.5, 0.6, 0.7, 0.8, 0.9, 1, 3, 5, or 10 μm, or any diameter within a range defined by any two of the aforementioned values. The pore size of the semi-permeable membrane 104 can be adjusted for the intended cells 101 to be processed. In some embodiments, the semi-permeable membrane 104 may include cellulose acetate (CA), glass fiber, nylon, polyethersulfone (PES), polypropylene (PP), polytetrafluoroethylene (PTFE), polyvinylidene fluoride (PVDF), regenerated cellulose (RC), or any other material generally used for semi-permeable membranes, which may optionally also be bio-inert.

As depicted in FIG. 1A, the exemplary apparatus may include a reagent supplier or supply 105. The reagent supplier or supply 105 may include a compatible conduit to supply liquid reagents 112, such as stains and wash reagents, into the staining container 100. In some embodiments, the reagent supplier can be operated manually, such as a pipette. In some embodiments, the reagent supplier 105 may be operatively connected to a reagent pump 113 that can provide the liquid reagents 112 and the mechanical force to pump the reagents through the reagent supplier 105 into the staining container 100. In some embodiments, the reagent supplier 105 and/or reagent pump 113 is optional, and supply of all reagents 112 may be performed manually, such as with a pipette. The addition of reagents 112 through the reagent supplier 105 (or alternatively done manually) generally indicates the beginning of a respective staining or washing step. In some embodiments, the reagent supplier 105 can be manipulated such that its position respective to the staining container 100 can be moved. In some embodiments, the reagent supplier 105 can also be used to deliver the initial suspension of cells 101 into the staining container 100 at the onset of apparatus operation (in which case 112 can represent the initial suspension of cells 101 at the starting step of apparatus operation).

As disclosed in the methods provided herein, the schematic of FIG. 1A may be representative of the initial step of loading cells 101 into the staining container 100 and representative of each of the one or more staining steps where the cells may be stained (e.g., with a cell morphological stain, immunocytochemical stain, or chromogenic in-situ hybridization stain) or washed. In this case, the liquid medium 103 represents the liquid reagent containing components such as small molecule stain, antibody, nucleic acid, or chromogenic reagent for each respective staining step, or a washing reagent to wash the cells after each staining step. In some embodiments, these liquid reagents and/or washing reagents may be delivered through the reagent supplier 105, or provided manually.

FIG. 1B depicts an intermediate position of the exemplary apparatus embodied in FIG. 1A indicating the extraction step. This extraction step may be performed following the initial cell loading step, to remove the starting liquid medium in which the cells may be suspended (and which may optionally contain fixatives and/or permeabilizing reagents), following each staining step, and following each washing step. During this extraction step, the extraction container 102can be manipulated such that the semi-permeable membrane 104 and at least a portion of the extraction container 102 may be submerged within the liquid medium 103 containing the cells 101. In some embodiments, the liquid medium 103 and any sufficiently small molecules such as components used for staining or wash may be allowed to flow from the staining container 100 into the extraction container 102 across the semi-permeable membrane 104 by passive diffusion while leaving the cells 101 in the staining container 100. In some embodiments, a negative pressure 107 in the extraction container 102 forces the liquid medium 103 and any sufficiently small molecules such as components used for staining or wash from the staining container 100 into the extraction container 102 across the semi-permeable membrane 104, while leaving the cells 101 in the staining container 100. In some embodiments, the negative pressure 107 may be exerted by the extraction pump 115. However, this extraction pump 115 may be optional, and the contents of the extraction container 102 may be manipulated manually. The extracted liquid 106 in the extraction container 102 may be removed as waste. In some embodiments, after removing the extracted liquid 106, a positive pressure of gas into the extraction container 102 can be used to dislodge any cells 101 that have been retained by the semi-permeable membrane 104 to return them back to a homogeneous suspension. The reagent supplier 105, reagent 112, and reagent pump 113 is not depicted in FIG. 1B. However, this is not intended suggest that the reagent supplier 105, reagent 112, and reagent pump 113 are necessarily removed or otherwise moved during the steps represented in FIG. 1B, and these components may or may not be present during the operation of the apparatus at any step.

The depth into the staining container 100 by which the extraction container 102 may be positioned may be adjusted, but it may be desirable to position the extraction container 102 such that the semi-permeable membrane 104 can be as close to the bottom of the staining container 100 to ensure extraction of as much of the liquid medium 103 as possible, but at the same time, leaving sufficient space to permit free flow of the liquid medium 103 and cells 101 without excessive shear force. Any liquid medium 103 that remains after this process can be diluted with appropriate wash steps to remove any unwanted components for subsequent steps.

As disclosed in the methods provided herein, the schematic of FIG. 1B may be representative for each of the one or more staining steps and washing steps, such that the liquid medium 103 represents the liquid reagent containing components such as small molecule stain, antibody, nucleic acid, or chromogenic reagent for each respective staining step, or a washing reagent to wash the cells after each staining step.

FIG. 1C depicts a schematic representing the final operation step of the exemplary apparatus embodied in FIG. 1A-B. At this stage, every staining and washing step has been performed, and the stained cells 110 have been sufficiently stained and washed as desired. The stained cells may have been contained in the staining container 100 throughout the entire staining and washing process, and can be resuspended in a final liquid medium 108. In some embodiments, the final liquid medium 108 may be a standard aqueous medium (e.g., phosphate buffered saline or other compatible buffer medium) or an aqueous medium that may be optimized for slide mounting, visualization, and/or stain stability (e.g., a mounting medium). The final stained cells 110 can be removed to mount on slides for diagnostic examination. In some embodiments, the slides that the stained cells 110 are mounted on may be any of the slide assemblies disclosed herein. Removal of the stained cells 110 may be done manually, such as with a pipette, or by way of a sample removal channel 109. In some embodiments, the sample removal channel 109 can remove the final liquid medium 108 and contained stained cells 110 by negative pressure. In some embodiments, the sample removal channel may be operatively connected to a separate apparatus for automated mounting onto a slide for visualization, including any one of the slide assemblies disclosed herein. The reagent supplier 105, reagent 112, and reagent pump 113 is not depicted in FIG. 1C. However, this does not suggest that the reagent supplier 105, reagent 112, and reagent pump 113 are necessarily removed or otherwise moved during the steps represented in FIG. 1C, and these components may or may not be present during the operation of the apparatus at any step. This also applies to the extraction container 102 and semi-permeable membrane 104. The absence of these components as depicted in FIG. 1C is not intended to suggest that these are necessarily removed during the operation of the apparatus, and the extraction container 102 and semi-permeable membrane 104 may or may not be present, or may be repositioned, such as to aid in performing the operation steps of FIG. 1C.

An additional non-limiting embodiment of an apparatus for performing multiplexed cytopathological staining in a “horizontal” configuration is depicted in FIG. 1D-F.

The initial set up of the exemplary apparatus is shown in FIG. 1D. A staining container 100 may be provided in which cells 101 isolated and/or purified from a biological sample from a patient may be contained in a suspension in a compatible liquid medium 103.

In some embodiments, the staining container 100 may be any container with an opening and inner volume appropriate to contain the cells 101 and liquid medium 103. In some embodiments, the staining container 100 may include a bio-inert material, such as plastic, glass, quartz, steel, titanium, ceramic, alumina, zirconia, or other materials commonly used in cell culture. In some embodiments, the staining container 100 may be a tube, cylindrical tube, square tube, cuvette, dish, plate or other container that can be used in cell culture. In some embodiments, the staining container 100 may be optically clear, transparent, or configured to permit visualization of the contents of the container. In some embodiments, the staining container 100 may be compatible with a holder that can keep the staining container 100 stationary until removed from the holder.

In some embodiments, the cells 101 isolated and/or purified from a biological sample from a patient may be fixed and/or permeabilized prior to addition to the staining container 100. In some embodiments, the cells 101 may be fixed and/or permeabilized in the staining container 100 prior to operating the apparatus. In some embodiments, the cells 101 may be fixed and/or permeabilized in the staining container 100 by operation of the apparatus.

As depicted in FIG. 1D, the exemplary apparatus may include an extraction container 102 that may be operatively connected to the staining container 100 but separated by a semi-permeable membrane 104 that may be permeable to the liquid medium 103 (and small molecules, such as proteins, antibodies, nucleic acids, or small molecule stains) but may not be permeable to the cells 101, as well as a shutter 111 adjacent to the semi-permeable membrane 104 that can be positioned to prevent any flow between the staining container 100 and the extraction container 102 across the semi-permeable membrane 104. In some embodiments, the extraction container 102 and/or the shutter 111 may include a bio-inert material, such as plastic, glass, quartz, steel, titanium, ceramic, alumina, zirconia, or other materials commonly used in cell culture. In some embodiments, the extraction container 102 may be a tube, cylindrical tube, square tube, or other shape that can be positioned to be operatively connected to the staining container 100, including adjacently, surrounding the staining container 100, or surrounded by the staining container 100, as long as the staining container 100 and the extraction container 102 can be separated by the semi-permeable membrane 104 and shutter 111. In some embodiments, the extraction container 102 and/or the shutter 111 may be optically clear to observe the contents of the container. In some embodiments, the extraction container 102 may be sealed except for the connection to the staining container 100 separated by the semi-permeable membrane 104 (which can be fully sealed with the shutter 111 and an extraction opening 114. In some embodiments, the extraction opening 114 of the extraction container 102 may be appropriately sized to allow for removal of its contents, such as with a syringe or pipette, optionally manually. In some embodiments, the extraction opening 114 of the extraction container 102 may be operatively connected to an extraction pump 115 that can provide negative pressure 107 to remove the contents of the extraction container 102. In this case, the extraction opening 114 may have a channel reaching up to or near the bottom of the extraction container 102 to permit extraction of any liquids in the extraction container 102. In some embodiments, the extraction pump 115 can also provide positive pressure, thereby permitting expulsion of the contents of the extraction container 102 into the staining container 100 when the shutter 111 may be open. Some embodiments may optionally exclude the extraction pump 115, and the contents of the extraction container 102 may be manipulated manually.

In some embodiments, the semi-permeable membrane 104 comprises pores that permit liquid and any sufficiently small molecules to cross the membrane but does not permit cells to cross the membrane. In some embodiments, the pores comprise a diameter of 0.05, 0.1, 0.2, 0.22, 0.3, 0.4, 0.45, 0.5, 0.6, 0.7, 0.8, 0.9, 1, 3, 5, or 10 μm, or any diameter within a range defined by any two of the aforementioned values. The pore size of the semi-permeable membrane 104 can be adjusted for the intended cells 101 to be processed. In some embodiments, the semi-permeable membrane 104 may include cellulose acetate (CA), glass fiber, nylon, polyethersulfone (PES), polypropylene (PP), polytetrafluoroethylene (PTFE), polyvinylidene fluoride (PVDF), regenerated cellulose (RC), or any other material generally used for semi-permeable membranes, which may optionally also be bio-inert.

As depicted in FIG. 1D, the exemplary apparatus may include a reagent supplier 105. The reagent supplier 105 may include any compatible conduit to supply liquid reagents 112, such as stains and wash reagents, into the staining container 100. In some embodiments, the reagent supplier can be operated manually, such as a pipette. In some embodiments, the reagent supplier 105 may be operatively connected to a reagent pump 113 that can provide the liquid reagents 112 and the mechanical force to pump the reagents through the reagent supplier 105 into the staining container 100. In some embodiments, the reagent supplier 105 and/or reagent pump 113 may be optional, and supply of all reagents 112 may be performed manually, such as with a pipette. The addition of reagents 112 through the reagent supplier 105 (or alternatively done manually) generally indicates the beginning of a respective staining or washing step. In some embodiments, the reagent supplier 105 can be manipulated such that its position respective to the staining container 100 can be moved. In some embodiments, the reagent supplier 105 can also be used to deliver the initial suspension of cells 101 into the staining container 100 at the onset of apparatus operation (in which case 112 can represent the initial suspension of cells 101 at the starting step of apparatus operation).

As disclosed in the methods provided herein, the schematic of FIG. 1D may be representative of the initial step of loading cells 101 into the staining container 100, but may also be representative of each of the one or more staining steps where the cells may be stained (e.g., with a cell morphological stain, immunocytochemical stain, or chromogenic in-situ hybridization stain) or washed. In this case, the liquid medium 103 represents the liquid reagent containing components such as small molecule stain, antibody, nucleic acid, or chromogenic reagent for each respective staining step, or a washing reagent to wash the cells after each staining step. In some embodiments, these liquid reagents and/or washing reagents may be delivered through the reagent supplier 105, or provided manually.

FIG. 1E depicts an intermediate position of the exemplary apparatus embodied in FIG. 1D indicating the extraction step. This extraction step may be performed following the initial cell loading step, to remove the starting liquid medium in which the cells may be suspended (and which may optionally contain fixatives and/or permeabilizing reagents), following each staining step, and following each washing step. During this extraction step, the shutter 111 (which is depicted as closed in FIG. 1D), may be opened, lifted, or otherwise removed such that the staining container 100 and the extraction container 102 may be separated by the semi-permeable membrane 104 and movement of liquid medium between the staining container 100 and extraction container 102 may be permitted across the semi-permeable membrane 104. In some embodiments, the liquid medium 103 and any sufficiently small molecules such as components used for staining or wash can flow from the staining container 100 into the extraction container 102 across the semi-permeable membrane 104 by passive diffusion while leaving the cells 101 in the staining container 100. In some embodiments, a negative pressure 107 in the extraction container 102 can be exerted to force the liquid medium 103 and any sufficiently small molecules such as components used for staining or wash from the staining container 100 into the extraction container 102 across the semi-permeable membrane 104, while leaving the cells 101 in the staining container 100. In some embodiments, the negative pressure 107 may be exerted by the extraction pump 115. However, this extraction pump 115 may be optional, and the contents of the extraction container 102 may be manipulated manually. The extracted liquid 106 may be removed as waste, such as through the extraction opening 114. Any liquid medium 103 that remains in the staining container 100 can be diluted with appropriate wash steps to remove any unwanted components for subsequent steps. In some embodiments, after removing the extracted liquid 106, a positive pressure of gas into the extraction container 102 can be used to dislodge any cells 101 that have been retained by the semi-permeable membrane 104 to return them back to a homogeneous suspension. The reagent supplier 105, reagent 112, and reagent pump 113 is not depicted in FIG. 1E. However, this is not intended to suggest that the reagent supplier 105, reagent 112, and reagent pump 113 are necessarily removed or otherwise moved during the steps represented in FIG. 1E, and these components may or may not be present during the operation of the apparatus at any step.

As disclosed in the methods provided herein, the schematic of FIG. 1E may be representative for each of the one or more staining steps and washing steps, such that the liquid medium 103 represents the liquid reagent containing components such as small molecule stain, antibody, nucleic acid, or chromogenic reagent for each respective staining step, or a washing reagent to wash the cells after each staining step.

FIG. 1F depicts a schematic representing the final operation step of the exemplary apparatus embodied in FIG. 1D-E. At this stage, every staining and washing step has been performed, and the stained cells 110 have been sufficiently stained and washed as desired. The stained cells may have been contained in the staining container 100 throughout the entire staining and washing process, and can be resuspended in a final liquid medium 108. In some embodiments, the final liquid medium 108 may be a standard aqueous medium (e.g., phosphate buffered saline or other compatible buffer medium) or an aqueous medium that may be optimized for slide mounting, visualization, and/or stain stability (e.g., a mounting medium). The final stained cells 110 can be removed to mount on slides for diagnostic examination. In some embodiments, the slides that the stained cells 110 may be mounted on may be any of the slide assemblies disclosed herein. Removal of the stained cells 110 may be done manually, such as with a pipette, or by way of a sample removal channel 109. In some embodiments, the sample removal channel 109 can remove the final liquid medium 108 and contained stained cells 110 by negative pressure. In some embodiments, the sample removal channel may be operatively connected to a separate apparatus for automated mounting onto a slide for visualization, including any one of the slide assemblies disclosed herein. The reagent supplier 105, reagent 112, and reagent pump 113are not depicted in FIG. 1F. However, this is not intended to suggest that the reagent supplier 105, reagent 112, and reagent pump 113 are necessarily removed or otherwise moved during the steps represented in FIG. 1F, and these components may or may not be present during the operation of the apparatus at any step.

Also disclosed herein are methods of using the apparatuses disclosed herein, such as those embodied in FIG. 1A-F, for multiplexed cytopathological staining of cells from a biological sample from a patient. In some embodiments, the staining steps comprise staining the cells with a cell morphological stain, immunocytochemical stain, or chromogenic in-situ hybridization stain, or any combination thereof. In some embodiments, the cell morphological stain comprises Diff-Quik, Papanicolaou stain, Wright-Giemsa stain, hematoxylin/eosin stain, or any derivatives or modifications thereof. In some embodiments, the cells comprise atypical cells. In some embodiments, the cells comprise cancer cells. In some embodiments, the cells comprise urinary sediment cells. In some embodiments, the urinary sediment cells can be stained for one or more bladder cancer specific biomarkers, optionally wherein the one or more bladder cancer specific biomarkers are selected from the group consisting of S100P, p63, M344, LDQ10, 19A211, GATA-3, Ki-67, p16, Her-2, PD-L1, CTLA4, CK-17, CK-20, nmp-22, bladder tumor antigen (BTA), hTERT, and mini-chromosome maintenance protein 5 (MCM5).

In any of the embodiments provided herein, the patient may be a mammal. In some embodiments, the patient may be a human.

### Cytopathology Slide Assemblies

Also disclosed herein are pathology slide assemblies comprising a pathology slide and a pathology coverslip. In some embodiments, the pathology slide and pathology coverslip can be sealed and define an internal void accessible by an inlet port and an outlet port of the pathology slide assembly. In some embodiments, a suspension of cells from a biological sample from a patient can be delivered to the internal void by the inlet port, and cell-depleted media can be expelled through the outlet port. In some embodiments, the thickness of the pathology slide assembly may be compatible with conventional light microscopes. For example, the pathology slide assembly may optically transparent. For example, the pathology slide assembly may be dimensioned such that the pathology slide assembly may be capable of interfacing with a stage of a light microscope. In some embodiments, the thickness of the pathology slide assemblies is 1000, 1100, 1200, 1300, 1400, or 1500 μm, or any thickness within a range defined by any two of the aforementioned values. In some embodiments, the thickness of the pathology slide is 600, 700, 800, 900, 1000, 1100, 1200, 1300, or 1400 μm, or any thickness within a range defined by any two of the aforementioned values. In some embodiments, the thickness of the pathology coverslip is 100, 110, 120, 130, 140, 150, 160, 170, 180, 190, 200, 210, 220, 230, 240, or 250 μm, or any thickness within a range defined by any two of the aforementioned values. In some embodiments, the surface of the pathology slide defining the internal void comprises a cell-adhesive material. In some embodiments, the cell-adhesive material may be an adhesive gel, protein coating, carbohydrate coating, or nanomaterial. In some embodiments, cells delivered to the internal void can settle and stick to the cell-adhesive material. In some embodiments, the pathology slide and/or the pathology coverslip may include an optically clear or transparent material. In some embodiments, the pathology slide and/or the pathology coverslip may include plastic, glass, quartz, or ceramic. In some embodiments, removal of the sealed coverslip may not be necessary for processing and effective visualization of the pathology slide assemblies.

In some embodiments, the inlet port and/or outlet port may be configured to protrude from the pathology coverslip to allow for easy access and connections. For example, the inlet port and/or outlet port may protrude to enable a fitting (e.g., a tube made of rubber, silicone, or the like) to be affixed to the inlet port and/or outlet port. In some embodiments, the inlet port and/or outlet port may have a protrusion height of 0.4, 0.5, 0.6, 0.7, or 0.8 cm, or any protrusion height within a range defined by any two of the aforementioned values, or any other compatible height for easy access and connections.

In some embodiments, the internal void comprises a single, uniform reservoir (“lake” reservoir). In such embodiments, there may not be microchannels within the internal void of the pathology slide assemblies. In some embodiments, removal of the sealed coverslip may not be necessary for processing and effective visualization of the pathology slide.

In some embodiments, the pathology coverslip can include one or more microfluidic channels, and the internal void comprises the negative space defined by the one or more microfluidic channels. In some embodiments, the one or more microfluidic channels can permit passage of the cells (e.g., the dimensions of the one or more microfluidic channels may be larger than the size of the cells). In some embodiments, the width of the negative space defined by each of the one or more microfluidic channels (e.g., the distance of negative space between two adjacent microfluidic channels of the pathology coverslip) is 300, 400, 500, 600, 700, 800, 900, 1000, 1100, or 1200 μm, or any width within a range defined by any two of the aforementioned values. In some embodiments, the height of the negative space defined by each of the one or more microfluidic channels (e.g., the distance from the surface of the pathology slide to the most distant surface of each of the one or more microfluidic channels) is 30, 40, 50, 60, 70, 80, 90, 100, 110, or 120 μm, or any height within a range defined by any two of the aforementioned values. In some embodiments, removal of the sealed coverslip containing the microfluidic channels may not be necessary for processing and effective visualization of the pathology slide assembly. This has certain benefits such as minimizing any disturbances of the stained and adhered cells on the slide and reducing unintentional cell sample loss. This may be advantageous in some embodiments, especially when analyzing rare target cells, such as circulating tumor cells which may only occur around 5-10 cells per slide.

In some embodiments, the surface of the pathology slide defining the internal void may be nanoroughened. In some embodiments, the nanoroughened surface enhances capture of the cells in suspension, for example, cancer cells. The use of nanoroughened surfaces for the capture of cancer cells, which exhibit atypical morphologies, is described in Chen et al., Nanoroughened Surfaces for Efficient Capture of Circulating Tumor Cells without Using Capture Antibodies, ACS Nano. 7 (1): 566-75 (2013), and Chen et al., Nanoroughened adhesion-based capture of circulating tumor cells with heterogeneous expression and metastatic characteristics, BMC Cancer. 16:614, 1-12 (2016), each of which is hereby expressly incorporated by reference in its entirety.

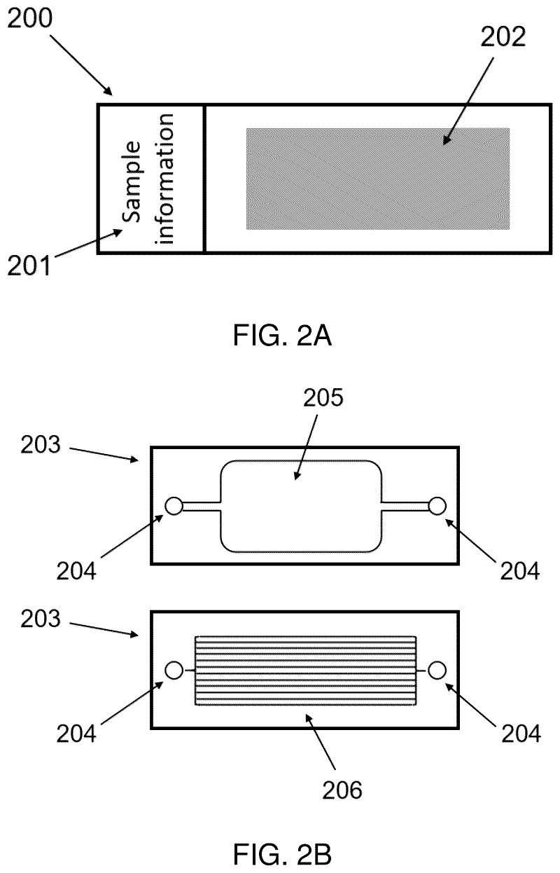

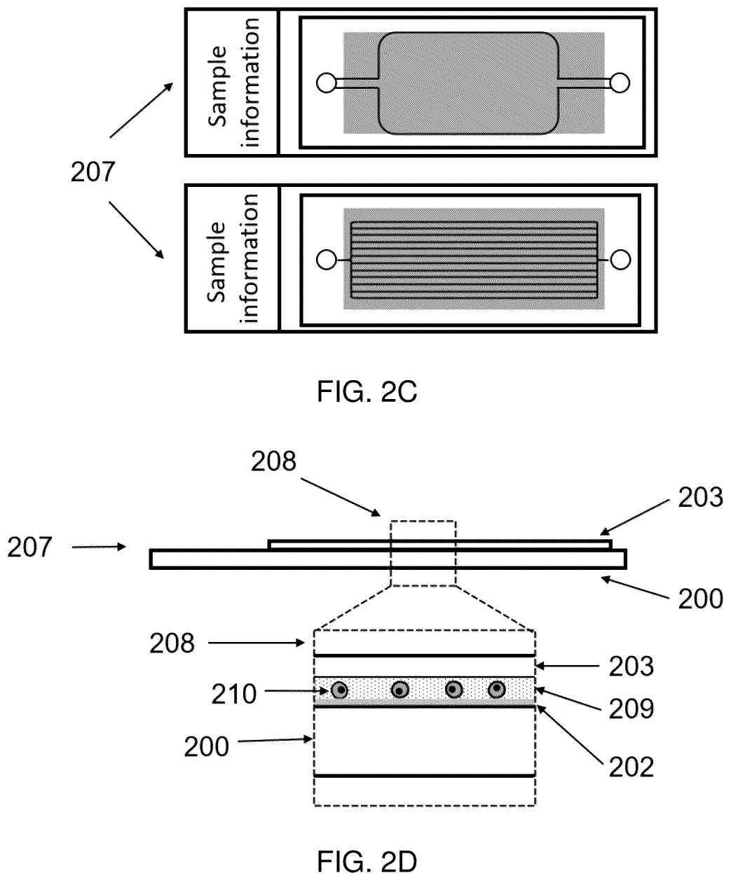

A non-limiting embodiment of a pathology slide for use in a pathology slide assembly is depicted in FIG. 2A. The pathology slide 200 may include an optically clear and/or transparent material configured for light microscopy, especially for cytology purposes, such as glass, plastic, quartz, or ceramic. In some embodiments, the pathology slide 200 has a thickness that may be compatible with conventional light microscopes. In some embodiments, the thickness of the pathology slide 200 is 600, 700, 800, 900, 1000, 1100, 1200, 1300, or 1400 μm, or any thickness within a range defined by any two of the aforementioned values. As common with other pathology slides, the pathology slide 200 may have a region 201 where sample information may be written or printed. In some embodiments, the pathology slide 200 may have a cell-adhesive material 202 that aids in the adherence of cells introduced to the pathology slide 200 in a pathology slide assembly to mount the cells. In some embodiments, the cell-adhesive material may be an adhesive gel, protein coating, carbohydrate coating, or nanomaterial, including cell-adhesive materials generally known in the art.

Two non-limiting embodiments of a pathology coverslip for use in a pathology slide assembly are depicted in FIG. 2B. The pathology coverslip 203 may include an optically clear and/or transparent material configured for light microscopy, especially for cytology purposes, such as glass, plastic, quartz, or ceramic. In some embodiments, the pathology coverslip 203 has a thickness that may be compatible with conventional light microscopes. In some embodiments, the thickness of the pathology coverslip 203 is 100, 110, 120, 130, 140, 150, 160, 170, 180, 190, 200, 210, 220, 230, 240, or 250 μm, or any thickness within a range defined by any two of the aforementioned values. In some embodiments, the pathology coverslip comprises an inlet port and an outlet port that can provide external access to a contiguous internal volume (e.g., microchannels or reservoir) of the pathology slide assembly. As depicted in FIG. 2B, the ports may be used as an inlet port or an outlet port interchangeably. In some embodiments, when adding liquids through the inlet port, the outlet port provides pressure equalization to the external atmosphere to allow flow through the internal void of the pathology slide assembly. In some embodiments, the inlet port and/or outlet port 204 may protrude from the pathology coverslip to allow for easy access and connections. For example, the inlet port and/or outlet port 204 may protrude to enable a fitting (e.g., a tube made of rubber, silicone, or the like) to be affixed to the inlet port and/or outlet port 204. In some embodiments, the inlet port and/or outlet port 204 may have a protrusion height of 0.4, 0.5, 0.6, 0.7, or 0.8 cm, or any protrusion height within a range defined by any two of the aforementioned values, or any other compatible height for easy access and connections.

In some embodiments, the pathology coverslip comprises a single hollowed region 205 of less thickness than the rest of the pathology coverslip, which defines a single, uniform, “lake”-type reservoir that contains the mounted cells when sealed with a pathology slide as a pathology slide assembly.

In some embodiments, the pathology coverslip comprises one or more microfluidic channels 206, where the internal void of the assembly including the pathology slide and pathology coverslip comprises the negative space defined by the one or more microfluidic channels. In some embodiments, the one or more microfluidic channels 206 permit passage of the cells (e.g., the dimensions of the one or more microfluidic channels may be larger than the size of the cells). In some embodiments, the width of the negative space defined by each of the one or more microfluidic channels 206 (e.g., the distance of negative space between two adjacent microfluidic channels of the pathology coverslip) is 300, 400, 500, 600, 700, 800, 900, 1000, 1100, or 1200 μm, or any width within a range defined by any two of the aforementioned values. In some embodiments, the height of the negative space defined by each of the one or more microfluidic channels 206 (e.g., the distance from the surface of the pathology slide to the most distant surface of each of the one or more microfluidic channels) is 30, 40, 50, 60, 70, 80, 90, 100, 110, or 120 μm, or any height within a range defined by any two of the aforementioned values.

Two non-limiting embodiments of a pathology slide assembly are depicted in FIG. 2C. Shown are pathology slide assemblies 207 when a pathology coverslip with either 1) a single “lake”-type reservoir or 2) microchannels may be used. To construct the full pathology slide assemblies, the pathology slide and pathology coverslip may be sealed together, ideally using a water-tight permanent adhesive to prevent leaking of the contents of the slide assembly (e.g., containing the cells) during processing and diagnostic review. The inlet port and outlet port 204 can permit access to the internal void of the pathology slide assembly when the pathology slide and pathology coverslip are sealed together. However, after the slide preparation and the mounting of desired cells to the slide, the inlet port and outlet port 204 may be sealed for long-term storage purposes. Generally, the pathology slide assemblies will be sealed with a compatible mounting medium filling the internal void to create a uniform optical pathway for visualization. Conventional mounting media generally also contain reagents to preserve cell morphology for storage.

A non-limiting cross section view and enlarged cross section view of an exemplary pathology slide assembly is depicted in FIG. 2D. The pathology slide assembly 207 may include a pathology slide 200 and pathology coverslip 203 as configured like common slide assemblies. The enlarged view 208 (not part of the assembly) shows a cross section of the pathology slide 200, the pathology coverslip 203, with an optional cell-adhesive material 202 on the pathology slide 200. The internal void 209 may be defined by internal surfaces of the pathology slide 200 and the pathology coverslip 203 of the pathology slide assembly 207. In some embodiments, this internal void may comprise a single “lake”-type reservoir or spaces defined by one or more microchannels 206 depending on the construction of the pathology coverslip 203. The cells 210 are depicted as adhered to the cell-adhesive material 202. In the final pathology slide assembly preparation, the cells may be contained in a mounting medium that enhances visualization for cytology purposes, such as mounting media generally known in the art. In some non-limiting embodiments, the mounting medium may comprise alpha-pinene, toluene, and/or 2,6-butylated hydroxytoluene. In some embodiments, the mounting medium comprises alpha-pinene at 25-60% w/w, toluene at 40-72% w/w, and 2,6-butylated hydroxytoluene at 1-3%. In some embodiments, the mounting medium comprises 27.5% alpha-pinene, 71.5% toluene, and/or 1% 2,6-butylated hydroxytoluene.

The pathology slide assemblies disclosed herein may be configured to be chained together by connecting the outlet port of one to the inlet port of another. Flowing a cell suspension sample through multiple pathology slide assemblies can increase the percentage of cells captured by the pathology slide assemblies (by the cell-adhesive material 202 thereof) for visualization. Using multiple pathology slide assemblies increases the available area for cell attachment, which may be advantageous when the cell suspension sample contains more cells than can be suitably adhered to a single pathology slide assembly. In some embodiments, the inlet port of a pathology slide assembly can be operatively connected by a chaining channel to an outlet port of a second pathology slide assembly; and/or the outlet port can be operatively connected by a chaining channel to an inlet port of a third pathology slide assembly. In some embodiments, the chaining channel may include any conventional material (such as rubber, silicone, and the like) with an internal channel through which liquids, for example samples containing stained cells or mounting medium can be flowed. In some embodiments, the ends of the chaining channel can be fitted to an inlet port and an outlet port, for example, by fitting over a protruding inlet port and outlet port. Effectively, the liquids will flow through the internal void of one pathology slide assembly (marking a first instance of cell mounting), through the outlet port, across the chaining channel, and through the inlet port of a second pathology slide assembly to the internal void of the second pathology slide assembly (marking a second instance of cell mounting).

Also disclosed herein are embodiments including a plurality of pathology slide assemblies comprising two or more of any of the pathology slide assemblies disclosed herein. In some embodiments, the two or more pathology slide assemblies can be consecutively chained through the inlet ports and outlet ports of each pathology slide assembly, such that the internal voids of the two or more pathology slide assemblies are in fluid communication, forming a contiguous space. In some embodiments, an exposed inlet port of one of the two or more pathology slide assemblies and an exposed outlet port of another one of the two or more pathology slide assemblies remain unchained to allow access to the contiguous space made up of the connected internal voids.

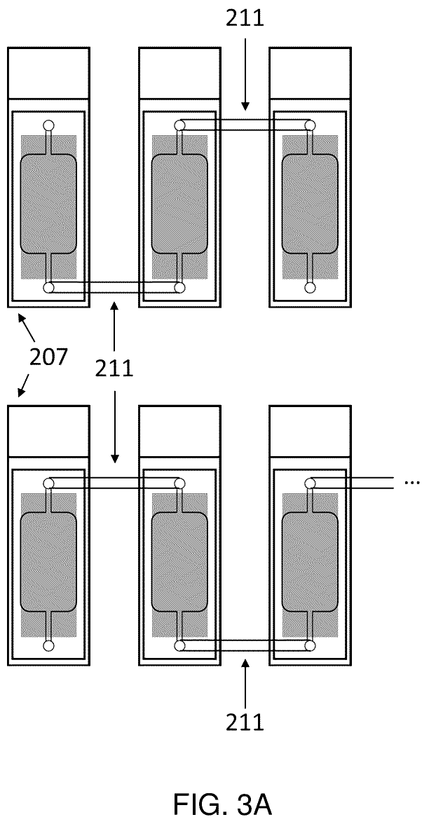

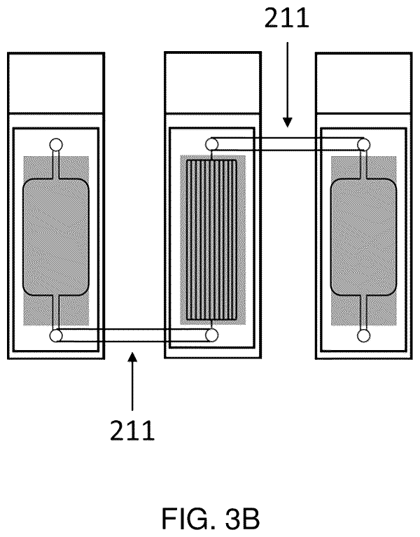

Non-limiting embodiments of a plurality of pathology slide assemblies are depicted in FIG. 3A-B. The pathology slide assemblies 207 represent any of the pathology slide assemblies disclosed herein. As discussed herein, a plurality of pathology slide assemblies, which each have an inlet port and an outlet port, can be connected or chained by connecting the outlet port of one pathology slide assembly to the inlet port of a second pathology assembly with a chaining channel 211. In some embodiments, the chaining channel 211 may be constructed of any conventional material (such as rubber, silicone, and the like) with an internal channel through which liquids, such as samples containing stained cells or mounting medium can be flowed. As in some embodiments the inlet port and outlet port can be materially the same, any one of the two openings (inlet port or outlet port) may be chained to any opening of the second pathology assembly. As such, it is to be understood that the chaining of pathology slide assemblies is not restricted to the particular configurations shown in FIG. 3A-B. As non-limiting embodiments depicted in FIG. 3B show, the pathology slide assemblies that make up the plurality of pathology slide assemblies need not be the same, and different pathology slide assembly constructions (e.g., having a reservoir type or microfluidic channel type internal void, having different microfluidic channel widths, having different cell-adhesive materials, etc.) may be configured as desired. Furthermore, while a chain of three pathology slide assemblies is depicted as non-limiting embodiments in FIG. 3A-B, any number of pathology slide assemblies (e.g., 2, 3, 4, 5, 6, 7, 8, 9, 10, and so on) may be chained together.

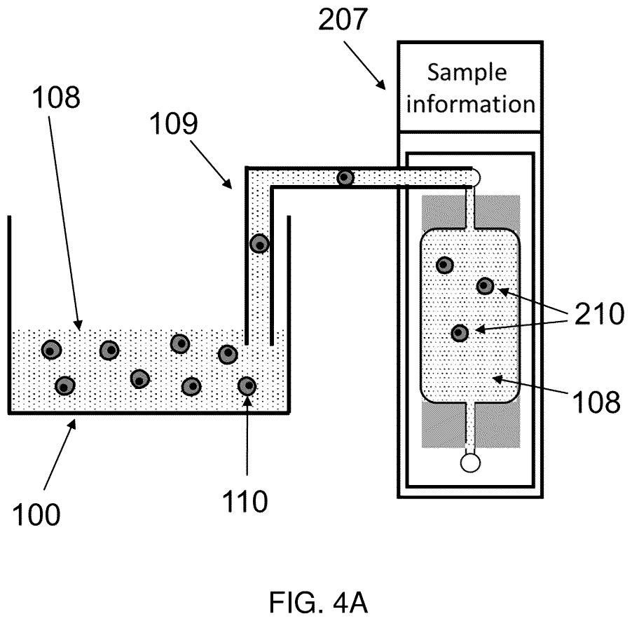

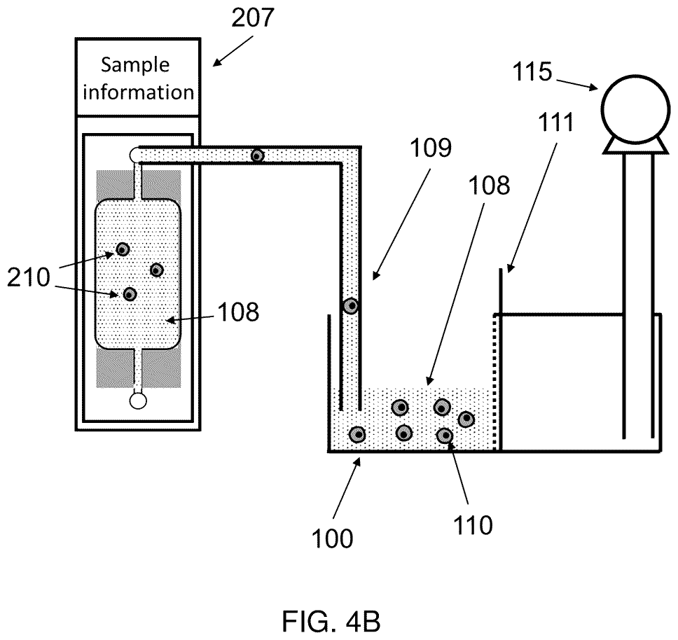

As depicted in FIG. 4A-B, some non-limiting embodiments include combined staining apparatuses. In some embodiments, the combined staining apparatuses comprise any one of the apparatuses disclosed herein and one or more pathology slide assemblies disclosed herein (where a plurality of pathology slide assemblies may be chained together as provided herein). In some embodiments, the combined staining apparatuses may comprise any one of the apparatuses disclosed herein and any one of the pathology slide assemblies disclosed herein, where the sample removal channel of the apparatus can operatively connect to the inlet port of the pathology slide assembly. In some embodiments, the combined staining apparatuses may comprise any one of the apparatuses disclosed herein and any one of the plurality of pathology slide assemblies disclosed herein, where the sample removal channel of the apparatus can operatively connect to the exposed inlet port of the plurality of pathology slide assemblies. In some embodiments, the sample removal channel may be configured to be compatible with the inlet port, for example, constructed to fit over an inlet port protrusion. In some embodiments, the sample removal channel may be operatively connected to the inlet port through another intermediate, such as a tube. As shown as a non-limiting embodiment in FIG. 4A, the apparatus may be in a “vertical” format. As shown as a non-limiting embodiment in FIG. 4B, the apparatus may be in a “horizontal” format.

Also disclosed herein are methods of mounting cells from a biological sample from a subject with any of the pathology slide assemblies, or any of the plurality of pathology slide assemblies, disclosed herein. The methods comprise flowing a suspension of the cells through a) the inlet port into the internal void of the pathology slide assembly; or b) the exposed inlet port of the plurality of pathology slide assemblies into the contiguous space of the plurality of pathology slide assemblies; and allowing the cells to settle and/or adhere to the surface of the pathology slide or pathology slides defining the internal void. In embodiments where the pathology slide may be coated with a cell-adhesive material, the cells can adhere to the cell-adhesive material. In some embodiments, the methods further comprise flowing a washing reagent and/or a mounting medium through the inlet port into the internal void of the pathology slide assembly (or the exposed inlet port into the contiguous space of the plurality of pathology slide assemblies) to replace the liquid component of the suspension of the cells (or whatever other liquid may be in the internal void, such as a previous washing reagent). In some embodiments, the cells can be retained in the internal void. In some embodiments, the liquid component of the suspension (or whatever other liquid may be currently in the internal void, such as a previous washing reagent) can be expelled through the outlet port (or the exposed outlet port of the plurality of pathology slide assemblies). In some embodiments, the methods include flowing a mounting medium as the final flowing step to fill the internal void (the internal void including adhered cells) with the mounting medium to create a uniform optical pathway for visualization. In some embodiments, after the final flowing step, the inlet port and outlet port may be sealed (for example, with an adhesive, epoxy, glue, or the like) to keep the cells in the mounting medium for storage. In some embodiments, the mounting medium may contain reagents to preserve cell morphology. In some embodiments, the methods further comprise visually inspecting the cells that may be settled and/or adhered to the surface of the pathology slide or pathology slides by light microscopy, such as for the detection of atypical cells in the biological sample, and further for pathological diagnosis of a disease. Generally, and as in some embodiments, for imaging the cells, the internal void will be filled with a compatible mounting medium to ensure a uniform optical pathway. In some embodiments, the cells can be fixed and/or permeabilized. In some embodiments, the cells can be stained by a cell morphological stain, immunocytochemical stain, or chromogenic in-situ hybridization stain, or any combination thereof. In some embodiments, the cells may be stained using any of the apparatuses for multiplexed cytopathological staining and/or any method of using the apparatuses disclosed herein. In some embodiments, the cell morphological stain comprises Diff-Quik, Papanicolaou stain, Wright-Giemsa stain, hematoxylin/eosin stain, or any derivatives or modifications thereof. In some embodiments, the cells comprise atypical cells. In some embodiments, the cells comprise cancer cells. In some embodiments, the cells comprise urinary sediment cells. In some embodiments, the urinary sediment cells can be stained for one or more bladder cancer specific biomarkers, optionally wherein the one or more bladder cancer specific biomarkers are selected from the group consisting of S100P, p63, M344, LDQ10, 19A211, GATA-3, Ki-67, p16, Her-2, PD-L1, CTLA4, CK-17, CK-20, nmp-22, bladder tumor antigen (BTA), hTERT, and mini-chromosome maintenance protein 5 (MCM5).

In any of the embodiments provided herein, the patient may be a mammal. In some embodiments, the patient may be a human.

### Alternative Slide Chamber Assembly

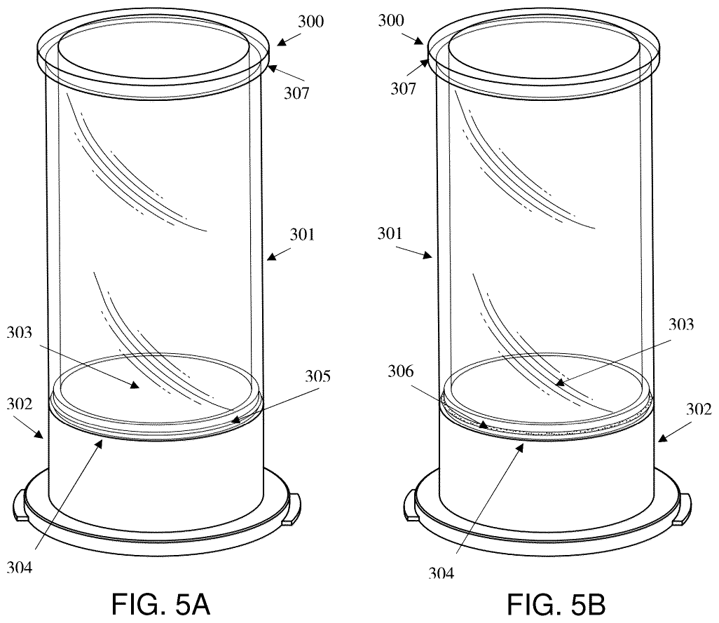

Additional, non-limiting embodiments of alternative staining chambers for use in an apparatus for performing multiplexed cytopathological staining are depicted in FIG. 5A-8. As depicted in FIGS. 5A and 5B, the alternative staining chamber 300, may comprise an upper portion, 301, and a lower portion 302. In some embodiments, upper portion 301 can be removed from the lower portion. In some embodiments, lower portion 302 may further comprise a porous membrane 303, where the porous membrane can be round, or oval in shape, up to 20 mm×20 mm in round shape, or 20 mm×40 mm in oval shape. In some embodiments, the upper portion 301 and lower portion may meet at a junction 304. As depicted in FIG. 5A, the junction 304 can be sealed via plastic molding 305, present in bottom portion 302 that interlocks with top portion 301. As depicted in FIG. 5B, the junction 304 can be sealed via a seal 306, present in bottom portion 302 that interlocks with top portion 301. In some embodiments, the seal 306 may include an elastomeric material, for example rubber. In some embodiments, the upper portion of the staining chamber may include a protruded rim 307 at the top of the staining chamber on the opposite side from the junction between the upper and lower portions.

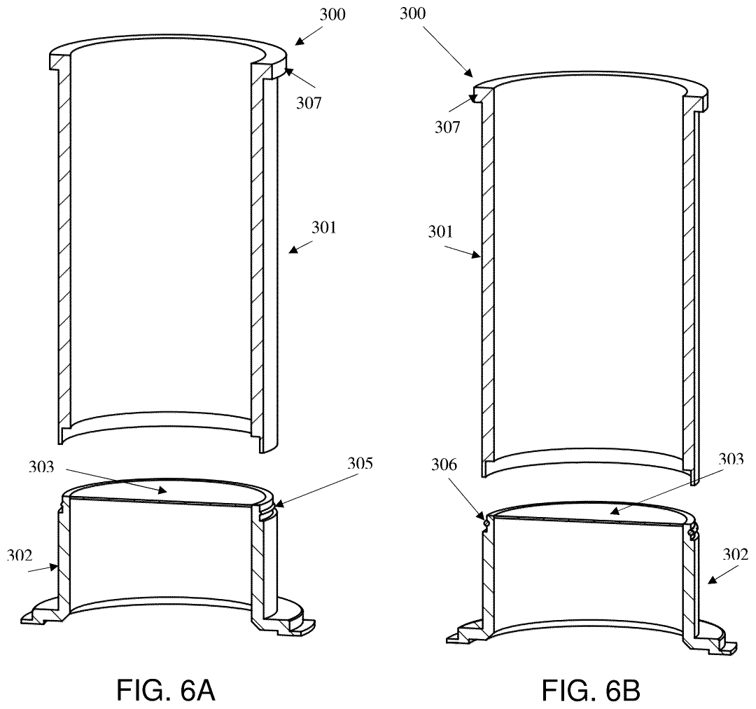

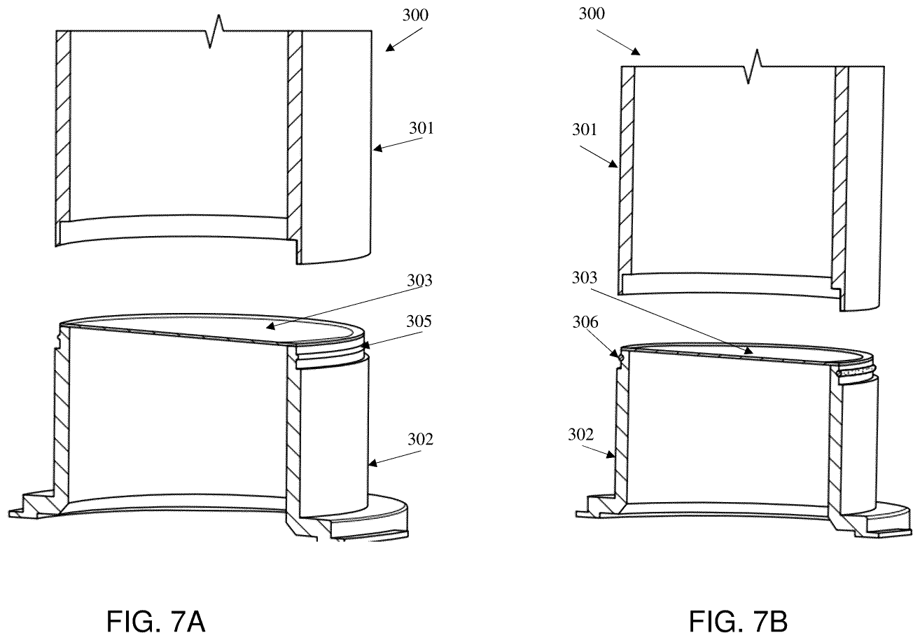

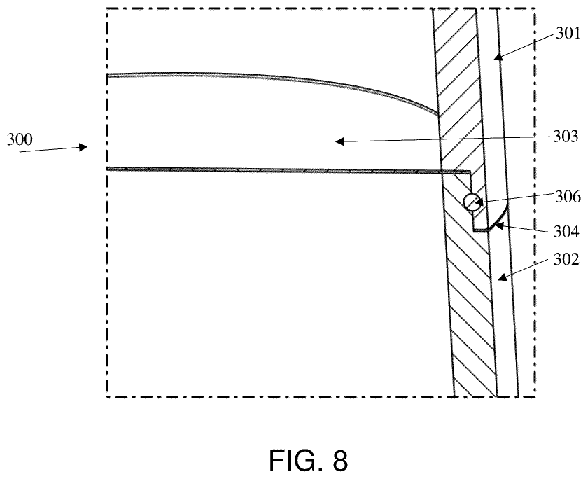

FIGS. 6A and 6B depict non limiting examples of cross sections of the alternative staining chamber 300 disassembled at the junction 304, separating the upper portion 301 from the lower portion 302. In some embodiments, following separation of the upper and lower portions, the porous membrane 303 may remain associated with the lower portion. As shown in FIG. 6A, in some embodiments, the plastic molding 305 that comprises the seal at the junction 304 may be associated with the lower portion 302 upon disassembly. As shown in FIG. 6B, in some embodiments, the seal 306 that comprises the seal at the junction 304 may be associated with the lower portion 302 upon disassembly. FIGS. 7A and 7B depict the cross sections of FIGS. 6A and 6B with better visibility of the junction 304 and seal 305, 306. FIG. 8 depicts a magnified view of the cross section of the junction 304 and seal 306 when the upper portion 301 and lower portion 302 are assembled, as in FIG. 5B. In some embodiments, the protruding rim 307 of the upper portion of the staining chamber is configured as an anchor to pull the staining chamber cylinder wall away and discard it after the staining process is complete (FIG. 5A-B, 6A-B). In some embodiments, stained cells can be exposed on the porous membrane 303 after removing upper portion 301. In some embodiments, following removal of the upper portion 301, the stained cells on the porous membrane 303 can be in direct contact with a pathology slide to transfer the stained cells onto it. In some embodiments, the cell transfer process may also be facilitated by blowing positive air pressure from under the porous membrane.

In some embodiments, the staining chamber 300, as depicted in FIG. 5A-8 can be used as an alternative to the staining chamber 103 and semi-permeable membrane 104 as shown in FIG. 1D-E. In some embodiments, the liquid reagents can be passed/aspirated downward through lower portion 302 and discarded. In some embodiments, new solutions can be added from the top of upper portion 301. In some embodiments, the wall of the staining chamber 301 can be removed after the staining process has been completed.

### Combined Staining Apparatus

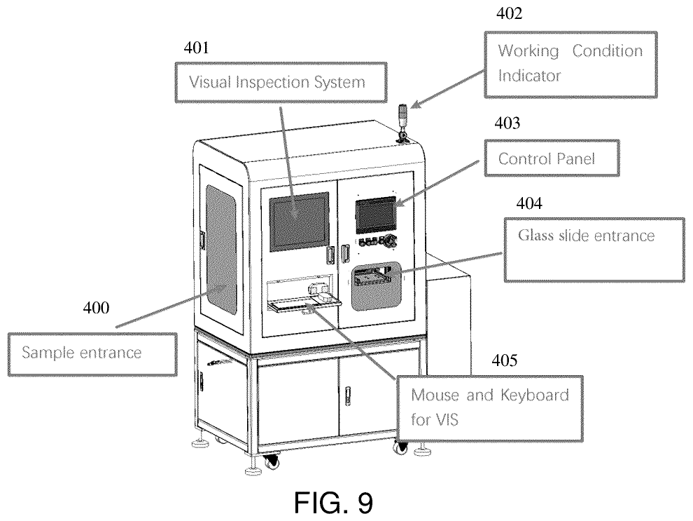

FIG. 9-15 depict non-limiting examples of a combined staining apparatus. In some embodiments, the combined staining apparatus may comprise a sample entrance 400, visual inspection system 401, working condition indicator 402, control panel 403, glass slide entrance 404, and mouse and keyboard 405 (FIG. 9). The sample entrance 400 may comprise a door that can allow passage of a sample to be loaded onto the apparatus. The visual inspection system 401 may include a hardware processor capable of processing images and/or a display. The working condition indicator 402 may be capable of indicating a status of the apparatus. In some embodiments, the working condition indicator 402 may include one or more light source capable of changing color to reflect a working condition of the apparatus. For example, the working condition indicator 402 might display a first color when ready to accept sample, may display a second color when processing the sample, and may display a third color when processing has completed. In some embodiments, the working condition indicator 402 may blink, turn on, and/or turn off to indicate a working condition of the apparatus. The working condition indicator 402 may include a speaker which may sound chimes and/or alarms to indicate a working condition of the apparatus. In some embodiments, the control panel 403 may allow a user to start, pause, stop, and/or end sample processing. In some embodiments, the control panel 403 may be a touch screen. In some embodiments, the control panel 403 may display a graphic indicative of progress through sample processing method executed by the apparatus. In some embodiments, the glass slide entrance 404 may allow a user to load one or more glass slides onto the apparatus. In some embodiments, the mouse and keyboard 405 may control the visual inspection system 401. In some embodiments, the mouse and keyboard 405 may control the control panel 403.

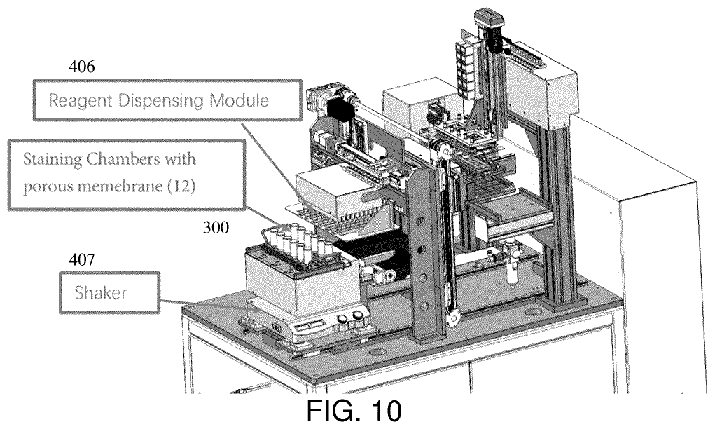

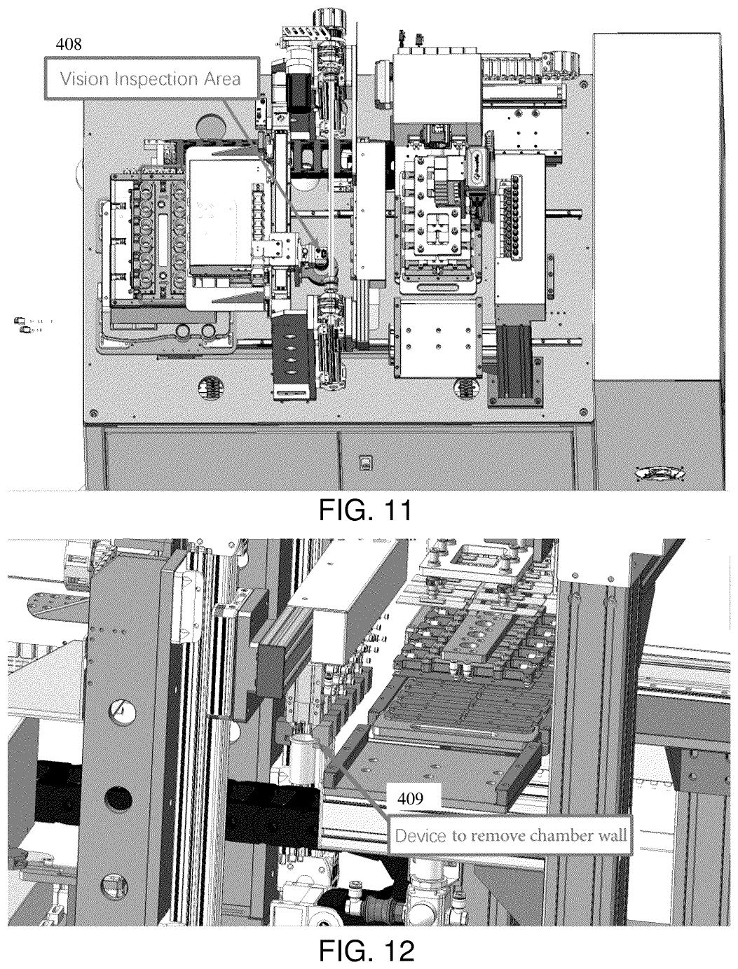

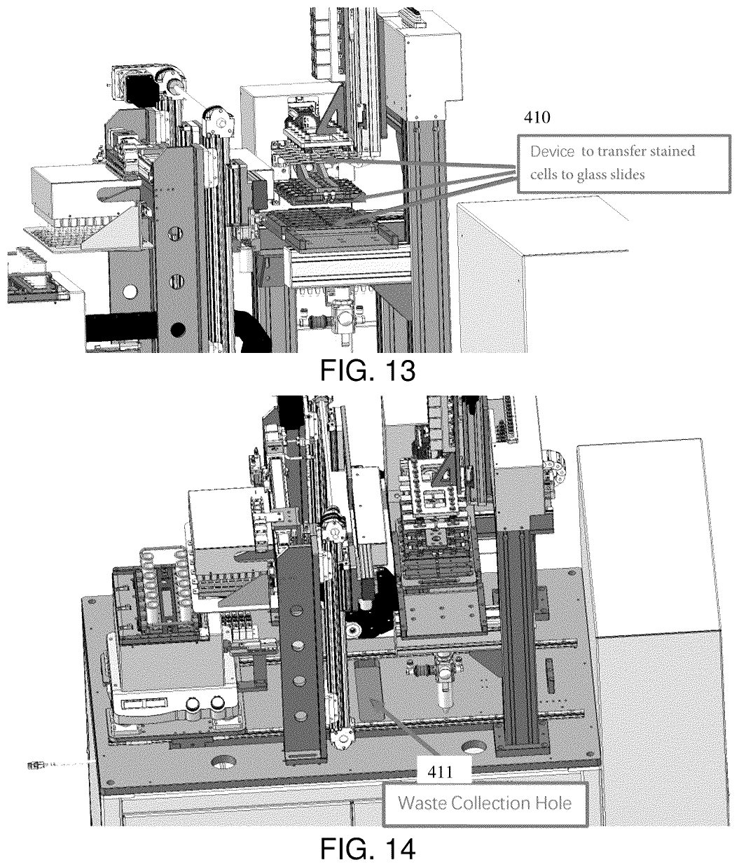

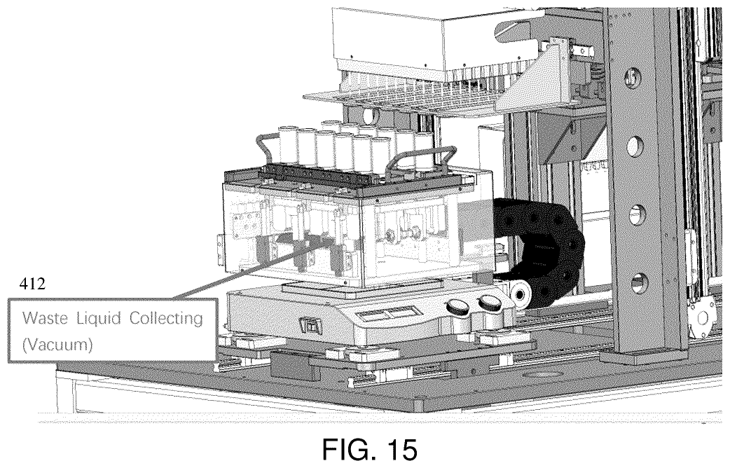

Now with reference to FIG. 10, in some embodiments, the apparatus may further comprise a reagent dispensing module 406. The reagent dispensing module 406 may be capable of dispensing one or more reagents to the staining chambers with porous membranes 300. The reagent dispensing module 406 may include a reagent supplier 105 and/or a reagent pump 113. The reagent dispensing module 406 may be controlled by a hardware processor. In some embodiments, staining chambers with a porous membrane 300 can be loaded into the apparatus, for example via the sample entrance 400. In some embodiments, the staining chambers can be positioned top of a shaker 407. The shaker 407 can shake the staining chambers 300, thereby moving reagents within the staining chambers 300. The shaker 407 may be controlled by a hardware processor. With reference to FIG. 11, in some embodiments, up to 12 staining chambers can be loaded into the apparatus simultaneously. In some embodiments, the shaker 407 is positioned on a set of tracks that allow the shaker 407 and the staining chambers 300 to move through the apparatus. Movement of the shaker 407 and the staining chamber 300 over tracks of the apparatus may be controlled by a hardware processor. In some embodiments, the apparatus comprises a vision inspection area 408. The vision inspection area 408 may include a camera capable of transmitting images to the visual inspection system 401. The camera of the vision inspection area 408 may be capable of imaging the staining chambers 300 and providing images of the staining chambers 300 to the visual inspection system 401 for determining whether staining is complete. With reference to FIG. 12, in some embodiments, the combined staining apparatus further comprises a gripper 409 that can remove a portion of the chamber wall. In some embodiments, the gripper 409 may engage with the protruding rim 307 of the upper portion of the staining chamber 301 to pull the staining chamber cylinder wall away from the lower portion 302 and discard the upper portion 301 after the staining process is complete. Now with reference to FIG. 13, in some embodiments, a transfer arm 410 can transfer stained cells to glass slides by pressing the exposed stained cells against the glass slides containing materials adhesive to the cells. In some embodiments, the cell transfer process can be facilitated with a pump that can generate positive air pressure under the porous membrane, thereby pushing cells on the membrane in an upward direction. Now with reference to FIG. 14, in some embodiments, the apparatus further comprises a waste collection hole or reservoir 411. In some embodiments, the gripper 409 can dispose of the upper portion to the waste collection hole or reservoir 411. Reagents, for example reagents used in a staining process, may be moved from the staining chamber 300. With reference to FIG. 15, in some embodiments, the apparatus further comprises a liquid waste collector 412. The liquid waste collector 412 can remove used reagents and/or liquid waste from the staining chamber 300. In some embodiments, the liquid waste collector 412 includes a pump that can create a negative pressure relative to the pressure of the upper portion 301 of the staining chamber. In some embodiments, the liquid waste collector 412 can remove used reagents from the staining chamber 300 to the waste collection hole or reservoir 411. In some embodiments, the processing of a liquid sample to a stained pathology slide is automated. In some embodiments, the processing of a liquid sample to a stained pathology slide is completed within a closed system. In some embodiments, the sample processing comprises approximately three hours.

1. An apparatus for performing multiplexed cytopathological staining, comprising:
a) a staining container configured to comprise an aqueous cell medium, staining reagents, washing reagents, and/or slide mounting medium and cells from a biological sample from a patient, and wherein the staining container is configured to perform alternating staining steps and washing steps to provide stained cells; and
b) an extraction container configured to receive used aqueous cell medium, used staining reagents, and/or used washing reagents from the staining container and permit removal of said used aqueous cell medium, used staining reagents, and/or used washing reagents;
wherein the staining container and the extraction container are operatively separated by a semi-permeable membrane that is permeable to the aqueous cell medium, staining reagents, washing reagents, and/or mounting medium but not permeable to the cells.

2-64. (canceled)
